(19) United States
(12) Patent Application Publication
(10) Pub. No.: US 2002/0055031 A1
(43) Pub. Date: May 9, 2002

(54) Fuel cell

(75) Inventors: Yosuke Fujii, Wako-Shi (JP); Takayuki Ogawa, Wako-Shi (JP); Hideaki Kikuchi, Wako-Shi (JP); Masaharu Suzuki, Wako-Shi (JP)

Correspondence Address: LAHIVE & COCKFIELD, 28 STATE STREET, BOSTON, MA, 02109, US

(73) Assignee: HONDA GIKEN KOGYO KABUSHIKI KAISHA, Tokyo (JP)

(21) Appl. No.: 10/010,051

(22) Filed: Nov. 9, 2001

(30) Foreign Application Priority Data
Nov. 9, 2000 (JP) P2000-341720
Nov. 13, 2000 (JP) P2000-345100

(51) Int. Cl. H01M 8/02; H01M 8/10

(52) U.S. Cl. 429/34; 429/32; 429/26; 429/30

(57) ABSTRACT

The fuel cell of the present invention comprises: a membrane electrode assembly including an electrolyte membrane held between an anode electrode and a cathode electrode; an anode side separator and a cathode side separator clamping the membrane electrode assembly; an oxidant gas channel provided on the cathode side separator, the oxidant gas channel starting from an oxidant gas channel inlet and reaching an oxidant gas channel outlet, the oxidant gas channel having a U-shape comprising a first route, a turning portion, and a second returning route; and a fuel gas channel provided on the anode side separator, the fuel gas channel starting from a fuel gas channel inlet and reaching a fuel gas channel outlet, the fuel gas channel having a U-shape comprising a first route, a turning portion, and a second returning route. The oxidant gas inlet and the oxidant gas outlet are provided in one side of the cathode side separator, and the fuel gas inlet and the fuel gas outlet are provided in the other side of the anode side separator.

### BACKGROUND OF THE INVENTION

1. Field of the Invention

The present invention relates to a fuel cell which produces an electric energy from a fuel gas and an oxidant gas (hereinafter referred to simply as reaction gas), and in particular, to a fuel cell in a reduced size, which can reduce the size of and can simplify a humidification device and its related equipment for humidifying the reaction gas.

2. Description of the Related Art

There has been developed a fuel cell in which an electrolyte membrane is held between an anode electrode and a cathode electrode, an oxidant gas is supplied to an oxidant gas channel between the cathode electrode and a cathode side separator which is located outside of the cathode electrode, a fuel gas is supplied to a fuel gas channel between the anode electrode and an anode side separator which is located outside of the anode electrode, to produce an electric energy.

In the conventional fuel cell, an oxidant gas outlet and a fuel gas outlet are provided diagonally to an oxidant gas inlet and a fuel gas inlet. There is unused areas around the oxidant gas inlet and the fuel gas inlet at one of the side of the separator and around the oxidant gas outlet and oxidant gas inlet provided at the other side. Therefore, the power generation performance is reduced, and the size of the fuel cell cannot be decreased.

As shown in FIG. 11, a separator 120 having the fuel gas inlet 121 and the fuel gas outlet 122 at the diagonal positions has hatched unused areas AA and BB.

In order to eliminate the unused areas to improve the power generation performance and to decrease the size of fuel cell, the oxidant gas inlet is provided at the upper side of the separator, the oxidant gas outlet is provided at the lower side, and the fuel gas inlet, the fuel gas outlet, the coolant inlet, and the coolant outlet are provided in one side (Japanese Unexamined Patent Application, First Publication No. 2000-195530).

However, in the technique disclosed in Japanese Unexamined Patent Application, First Publication No. 2000-195530, the fuel gas inlet 101, the fuel gas outlet 102, the coolant inlet 103, and the coolant outlet 104 are concentrated. Further, in order to obtain the necessary amount of the coolant, the coolant inlet 103 and the coolant outlet 104 must be long in the vertical direction. Therefore, the height of the fuel cell cannot be decreased.

When the conventional fuel cell is mounted in a vehicle, the conventional fuel cell is disadvantageous in the layout design, When an anode side separator 100 (FIG. 9) and a cathode side separator 110 (FIG. 10) hold the membrane electrode assembly (MEA), a communicating groove 108 for communicating the fuel gas inlet 100 with a fuel gas channel 107, and a communicating groove 112 for communicating the oxidant gas inlet 105 are located at the same side of the anode side separator 100 and the cathode side separator 110 facing each other.

Therefore, when the reaction gas which is not humidified or is slightly humidified is supplied to the gas inlets 101 and 105, a dry reaction gas is introduced into the gas channels 107 and 111.

In order to maintain the electrolyte membrane in the saturated water condition to act as a proton conductive electrolyte membrane, the reaction gas must be sufficiently humidified by a humidification device outside the fuel cell. The humidification device and its related equipment may be increased in size and become complicated.

There has been developed a solid polymer electrolyte type fuel cell which, for instance, constituted by laminating a plurality of units, with one unit being such that a membrane electrode assembly (MEA) provided with an anode and a cathode at opposite positions with a solid polymer electrolyte membrane inserted therebetween is clamped by separators, and this has been utilized for various practical applications.

In this type of fuel cell, a fuel gas, for example a hydrogen gas, supplied to the anode side is turned into hydrogen ions on a catalytic electrode, and moves to the cathode via the appropriately humidified solid polymer electrolyte membrane. Electrons generated during this electrochemical reaction are taken out to an external circuit, and are used as direct-current electric energy. Since an oxidant gas, for example, an oxygen containing gas or air is supplied to the cathode, the hydrogen ions, the electrons and the oxidant gas react with each other at the cathode, to thereby generate water.

Here, a sealing member is intervened between the membrane electrode assembly and the separators provided at opposite positions on both thereof to ensure airtightness, so that the fuel gas and the oxidant gas supplied to the anode and the cathode do not leak outside, and a reactant gas channel for guiding the fuel gas and the oxidant gas is provided on the surface of the separator, in a portion surrounded by the sealing member (see Japanese Patent No. 2711018).

This will be described with reference to FIG. 24. In FIG. 24, reference symbol 1001 denotes a separator (anode side separator). A concave portion is formed in the center of the separator 1001, and a meandering groove 1003 is formed in the concave portion. A reaction gas supply hole 1004 is provided in the upper left side of the concave portion 1002 of the separator 1001, and a reaction gas exhausting hole 1005 is provided in the lower right side. The reaction gas supply hole 1004 and the reaction gas exhausting hole 1005 communicate with the meandering groove 1003 via a fluid inlet 1006 and a fluid outlet 1007.

The reaction gas supplied from the supply hole 1004 is introduced through the fluid inlet 1006 into the meandering groove 1003, undergoes efficient reaction, and is exhausted through the fluid outlet 1007 to the exhausting hole 1005.

However, when, in the background art, the water contained in the reaction gas or produced by the reaction is condensed while blocking the meandering groove 1003. The condensed water may not be exhausted, and the reaction becomes uneven at the positions where the reaction gas is hard to flow.

When the load is low, the flow speed of the reaction gas is relatively decreased, and the condensed water is not exhausted. When too much reaction gas flows to exhaust the condensed water, the efficiency of the system may be decreased as the utilization rate of the reaction gas is decreased.

### BRIEF SUMMARY OF THE INVENTION

It is therefore an object of the present invention to provide a fuel cell which humidifies the reaction gas at the reaction gas inlet, to decrease the size of, and simplify the humidification device and its related equipment.

It is an object of the present invention to provide a fuel cell which can reduce its height with separators which are long from side to side.

It is an object of the present invention to provide a fuel cell, and a gas channel plate for the fuel cell which can sufficiently exhaust the condensed water from the gas channel, and which can increase the utilization rate of the gas when the load is low.

In the first aspect of the present invention, a fuel cell comprises: a membrane electrode assembly including an electrolyte membrane held between an anode electrode and a cathode electrode; an anode side separator and a cathode side separator clamping the membrane electrode assembly; an oxidant gas channel provided on the cathode side separator, the oxidant gas channel starting from an oxidant gas channel inlet and reaching an oxidant gas channel outlet, the oxidant gas channel having a U-shape comprising a first route, a turning portion, and a second returning route; and a fuel gas channel provided on the anode side separator, the fuel gas channel starting from a fuel gas channel inlet and reaching a fuel gas channel outlet, the fuel gas channel having a U-shape comprising a first route, a turning portion, and a second returning route. The oxidant gas inlet and the oxidant gas outlet are provided in one side of the cathode side separator, and the fuel gas inlet and the fuel gas outlet are provided in the other side of the anode side separator.

According to the first aspect of the invention, the reaction gas inlet provided in one of the separators is located at the turning portion of the reaction as channel on the other reaction gas channel. The condensed water collected at the turning portion diffuses (back-diffusion) from the cathode side through the electrolyte membrane to the anode side, and moves to the other gas channel, promoting the humidification of the other reaction gas. Thus, the humidification device and its related equipment can be made smaller and can be simplified.

In the second aspect of the present invention, a coolant inlet is provided at one of an upper side and lower side of the separators, a coolant outlet is provided at the other of the upper side and lower side of the separators.

According to the second aspect of the invention, in addition to the above-mentioned effect, the vertical width of the openings for the reaction gas can be narrow while the necessary amount of the coolant can be obtained. Therefore, the height of the fuel cell can be decreased, and can be mounted under a floor or a trunk of a car. Thus, the fuel cell is advantageous in the layout design even when the fuel cell is mounted in a space with a narrow vertical height.

In the third aspect of the present invention, a fuel cell comprises: a membrane electrode assembly including an electrolyte membrane held between an anode electrode and a cathode electrode; a pair of separator clamping the membrane electrode assembly; and a plurality of gas channels provided on a gas channel surface of the separator, the gas channel surface facing the anode or cathode electrode, the gas channels starting from a gas channel inlet and reaching a gas channel outlet, wherein the gas channels partially merge.

According to the third aspect of the present invention, when operating the fuel cell while water is condensed in the gas channels of the separator, the speed of the gas is increased, and as a result, the water condensed in the gas channels can be effectively discharged, preventing the gas channels from being blocked, thereby providing the uniform reaction on the gas channel surface of the separator.

Depending on the load, two pars of the gas channels, or a pair of the gas channels is chosen to vary the area of the reaction gas flow in the electrode. The apparent current density can be adjusted to increase the system efficiency. When the load is low, a pair of gas channels is used, more reaction gas than necessary does not have to flow in order to discharge the produced water. Hence, the utilization rate of the reaction gas is increased, and the system efficiency is also increased.

In the fourth aspect of the present invention, each of the gas channels has a U-shape comprising a first route, a turning portion, and a second returning route, and the second returning routes of the gas channels merge.

In the fifth aspect of the present invention, the gas channel inlet and the gas channel outlet of the separator close to the anode electrode are provided in one side, and the gas channel inlet and the gas channel outlet of the separator close to the cathode electrode are provided in the other side.

According to the fifth aspect of the present invention, water accumulated in the turning portions of the cathode side separator passes through the solid polymer electrolyte membrane and back diffuses and moves to the gas channel inlet of the anode side separator, promoting the humidification. Therefore, the humidification device can be made smaller as the gas is sufficiently humidified, and related equipment for discharging water can be simplified as the water to be discharged is decreased. Further, the returning routes of the anode side separator 1011, which flow together, correspond to the returning routes, which flow together and contain much water. Hence, the returning routes, which do not contain much water, can be humidified by back-diffusion.

In the sixth aspect of the present invention, the turning portion acts as a buffer.

According to the sixth aspect of the present invention, even if the condensed water blocks a part of the grooves, a buffer introduces the reaction gas into the grooves which are not blocked. In this case, the effective reaction area is not significantly reduced.

In the seventh aspect of the present invention, each gas channel comprises a plurality of sub-channels.

According to the seventh aspect of the present invention, even if the condensed water blocks one gas channel, the other gas channels allow the reaction gas to flow. Thus, the reliability is increased as compared with a device with a single gas channel.

In the eighth aspect of the present invention, the cross-sectional area of the first routes is greater than the cross-sectional area of the second returning routes.

According to the sixth aspect of the present invention, the speed of the gas is increased, and as a result, the water condensed in the gas channels can be effectively discharged.

In the ninth aspect of the present invention, the gas channel plate for a fuel cell, comprises: a plurality of gas channels provided on a gas channel surface of the separator, the gas channel surface facing the anode or cathode electrode, the gas channels starting from a gas channel inlet and reaching a gas channel outlet, wherein the gas channels partially merge.

In the tenth aspect of the present invention, in the second returning converging routes, the speed of the gas is increased, and as a result, the water condensed in the gas channels can be effectively discharged, preventing the gas channels from being blocked.

### BRIEF DESCRIPTION OF THE DRAWINGS

FIG. 1 is a plan view of a cathode side separator in an embodiment of the present invention.

FIG. 2 is a back view of the cathode side separator shown in FIG. 1.

FIG. 3 is a plan view of an anode side separator in the embodiment of the present invention.

FIG. 4 is a back view of the anode side separator shown in FIG. 3.

FIG. 5 is a cross-section of a fuel cell along the line A-A in FIG. 2.

FIG. 6 is a cross-section of a fuel cell along the line B-B in FIG. 2.

FIG. 7 is a cross-section of a fuel cell along the line C-C in FIG. 2.

FIG. 8 is a cross-section of a fuel cell along the line D-D in FIG. 2.

FIG. 9 is a plan view of an anode side separator of the background art.

FIG. 10 is a plan view of an cathode side separator of the background art.

FIG. 11 is a plan view of a cathode side separator of the background art.

FIG. 12 is a plan view of a cathode side separator in a second embodiment of the present invention.

FIG. 13 is a back view of the cathode side separator shown in FIG. 12.

FIG. 14 is a plan view of an anode side separator in the second embodiment of the present invention.

FIG. 15 is a back view of the anode side separator shown in FIG. 14.

FIG. 16 is a cross-section of a fuel cell along the line A-A in FIG. 13.

FIG. 17 is a cross-section of a fuel cell along the line B-B in FIG. 13.

FIG. 18 is a cross-section of a fuel cell along the line C-C in FIG. 13.

FIG. 19 is a cross-section of a fuel cell along the line D-D in FIG. 13.

FIG. 20 is a cross-section of a fuel cell along the line E-E in FIG. 13.

FIG. 21 is a plan view of a cathode side separator in a third embodiment of the present invention.

FIG. 22 is a perspective view showing manifold members of the third embodiment of the present invention.

FIG. 23 is a back view of the cathode side separator shown in FIG. 21.

FIG. 24 is a plan view of the prior art.

### DETAILED DESCRIPTION OF THE INVENTION

First embodiments of the present invention will now be described with reference to the drawings.

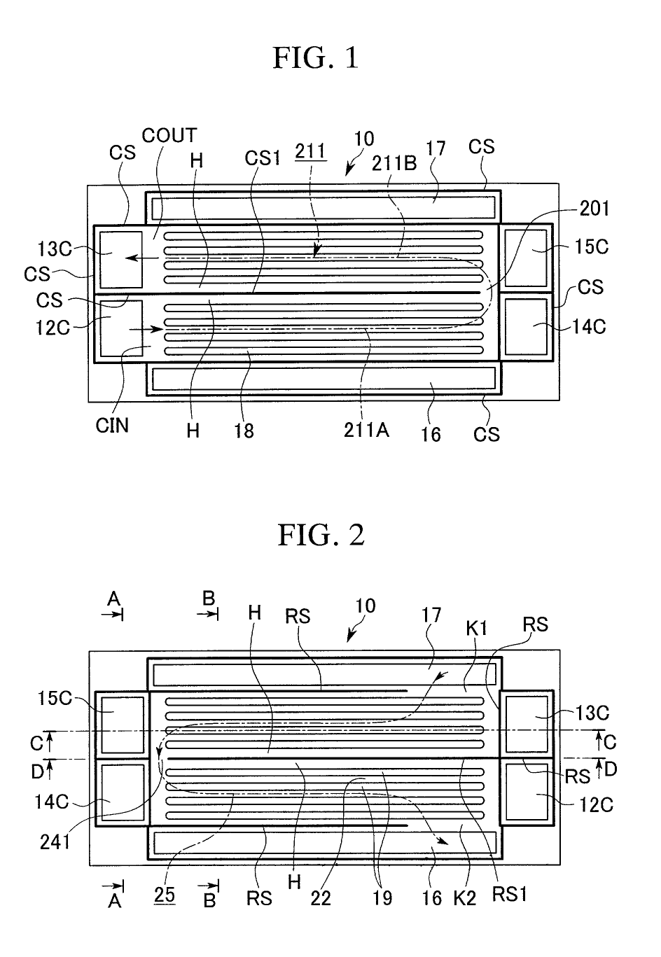

FIG. 1 shows a cathode side separator 10 which is press-formed from a metal material such as a stainless steel sheet material.

The cathode side separator 10 clamps a membrane electrode assembly together with an anode side separator 11 described later, to thereby constitute a fuel cell. These are further laminated in a plurality of sets in the horizontal direction, to thereby constitute a fuel cell stack mounted on, for example, vehicles.

In the cathode side separator 10, there are formed two communicating holes 12C and 13C at the left side edge, and two communicating holes 14C and 15C at the right side edge, respectively.

At the upper side edge and the lower side edge, there is respectively formed one communicating hole 16, 17.

That is to say, this embodiment is a so-called internal manifold type.

Specifically, the inlet side communicating hole 12C for an oxidant gas (for example, air) is formed on the lower side of the left side edge of the cathode side separator 10, and the outlet side communicating hole 13C for the oxidant gas is formed in the upper side of the left side edge.

On the other hand, the inlet side communicating hole 14C for a fuel gas (for example, hydrogen containing gas) is formed on the upper side of the right side edge of the cathode side separator 10, and the outlet side communicating hole 15C for the fuel gas is formed in the upper side of the right side edge of the cathode side separator 10.

Moreover, the outlet side communicating hole 16 for a coolant (for example, ethylene glycol) is formed at the lower side edge of the cathode side separator 10, and the inlet side communicating hole 17 for the coolant is formed at the upper side edge thereof. The holes 16 and 17 are long from side to side.

The portion surrounded by the communicating holes 12C and 13C for the oxidant gas, the communicating holes 14C and 15C for the fuel gas, and the communicating holes 17 and 16 for the coolant is constructed as a rectangular gas channel surface which faces the cathode electrode, and to which the oxidant gas is supplied.

On the gas channel surface, there are provided a plurality of grooves (sub-channels) 18 extending linearly in the lateral direction in units of four grooves by press forming. The grooves 18 are concave portions of the portions formed in a corrugation, and on the backside of the cathode side separator 10 shown in FIG. 2, these are formed as protruding members 19.

The end portion on the left of each groove 18 is arranged with a predetermined space from the right side edge position of each communicating hole 12C and 13C for the oxidant gas, and the end portion on the right of each groove 18 is arranged with a predetermined space from the left side edge position of each communicating hole 14C and 15C for the fuel gas.

Referring to FIG. 1, the peripheries of the inlet side communicating hole 14C and the outlet side communicating hole 15C for the fuel gas, and the inlet side communicating hole 17 and the outlet side communicating hole 16 for the coolant are surrounded by a sealing member CS, respectively.

Moreover, the inlet side communicating hole 12C and the outlet side communicating hole 13C for the oxidant gas are surrounded by the sealing member CS, with the exception of the right side edge thereof.

That is to say, the inlet side communicating hole 12C and the outlet side communicating hole 13C for the oxidant gas are communicated with the reaction plane at the right side edge, respectively.

A sealing member CS is provided between the inlet side communicating hole 12C and the outlet side communicating hole 13C for the oxidant gas. This sealing member CS extends between the grooves 18 on the gas channel surface without a seam, and has an extended portion CS1 reaching to the vicinity of the right side end portions of the grooves 18. The sealing member CS and the extended member CS1 are attached by injection, baking (stoving), bonding, or the like.

Here, the spaces between the grooves 18 where the extended portions CS1 and CS2 are provided means the spaces between respective units of the grooves 18 formed in units as described above, and these portions are flat surfaces H where the press forming is not performed.

Here, a space for forming a connecting path (turning portion) 201 is ensured between the right side end portion of the extended portion CS1 and the sealing member CS arranged at a position facing this extended portion CS1. The connecting path 201 serves as a buffer for collecting the reaction gas upstream.

The end of the groove 18 in the side of the inlet side communicating hole 12C serves as a gas channel inlet CIN. The end of the groove 18 in the side of the outlet side communicating hole 13C serves as a gas channel outlet COUT. The gas channel inlet CIN and the gas channel outlet COUT serve as a part of the buffer.

As a result, on the gas channel surface of the cathode side separator 10, there are formed a U-shaped reactant gas (oxidant gas) channel 211 with the extended portion CS1 being the boundary portion, and the connecting path 201 being the turning portion.

That is, the U-shaped gas channel 211 comprises a first route 211A from the gas channel inlet CIN in the side of the inlet side communicating hole 12C to the communicating path 201 as the turning portion, and a second returning route 211B from the communicating path 201 to the gas channel outlet COUT in the side of the outlet side communicating hole 13C.

On the other hand, FIG. 2 shows the cathode side separator 10 in FIG. 1 as seen from the backside. Therefore, the right side edge in FIG. 2 corresponds to the left side edge in FIG. 1, and the left side edge in FIG. 2 corresponds to the right side edge in FIG. 1. Specifically, the inlet side communicating hole 12C for the oxidant gas is respectively formed on the lower side of the right side edge thereof, and the outlet side communicating hole 13C for the oxidant gas is formed in the upper side of the right side edge. Also, the inlet side communicating hole 14C for the fuel gas is formed on the lower side of the left side edge thereof, and the outlet side communicating hole 15C for the fuel gas is formed in the lower side of the left side edge.

Moreover, the outlet side communicating hole 16 for the coolant is formed at the lower side edge of the cathode side separator 10, and the inlet side communicating hole 17 for the coolant is formed at the upper side edge thereof, as in FIG. 1. The communicating holes 16 and 17 are long from side to side.

On the cooling plane, there are formed protruding members 19 at positions corresponding to the grooves 18 described referring to FIG. 1. Therefore, these protruding members 19 are formed in units of four ribs, similarly to the grooves 18. Here, the protruding members 19 are convex portions of the portions formed in a corrugation. Therefore, grooves 22 are formed between adjacent protruding members 19. The end portion on the right of each protruding member 19 is arranged with a predetermined space from the left side edge position of each communicating hole 12 and 13C for the oxidant gas, and the end portion on the left of each protruding member 19 is arranged with a predetermined space from the right side edge position of each communicating hole 14C and 15C for the fuel gas.

Referring to FIG. 2, the peripheries of the inlet side communicating hole 12C and the outlet side communicating hole 13C for the oxidant gas, the inlet side communicating hole 14C and the outlet side communicating hole 15C for the fuel gas are surrounded by a sealing member RS, respectively.

The periphery of the outlet side communicating hole 16 for the coolant is also surrounded by the sealing member RS, with the exception of the portion where a part of the cooling plane side (the left side in FIG. 2) is excised as a notch portion K2.

The periphery of the inlet side communicating hole 17 for the coolant is surrounded by the sealing member RS, with the exception of the portion where a part of the cooling plane side (the right side in FIG. 2) is excised as a notch portion K1.

That is to say, the inlet side communicating hole 17 for the coolant is communicated with the cooling plane in the notch portion K1, and the outlet side communicating hole 16 is communicated with the cooling plane in the notch portion K2.

A sealing member RS is provided between the inlet side communicating hole 12C and the outlet side communicating hole 13C for the oxidant gas, and this sealing member RS extends between the protruding members 19 on the cooling plane without a seam, and has an extended portion RS1 reaching to the vicinity of the left side end portions of the protruding members 19.

The sealing member RS and the extended portion RS1 are attached by injection, baking, bonding or the like.

Here, the spaces between protruding members 19 where the extended portion RS1 is provided means the spaces between respective units of the protruding members 19 formed in units as described above, and these portions are flat surfaces H where the press forming is not performed.

Here, a space for forming a connecting path 241 is ensured between the right side end portion of the extended portion RS1 and the sealing member RS arranged at a position facing this extended portion RS1.

As a result, on the cooling plane of the cathode side separator 10, there is formed a meandering coolant channel 25 with the extended portion RS1 being the boundary portion, and the connecting path 241 being the turning portion.

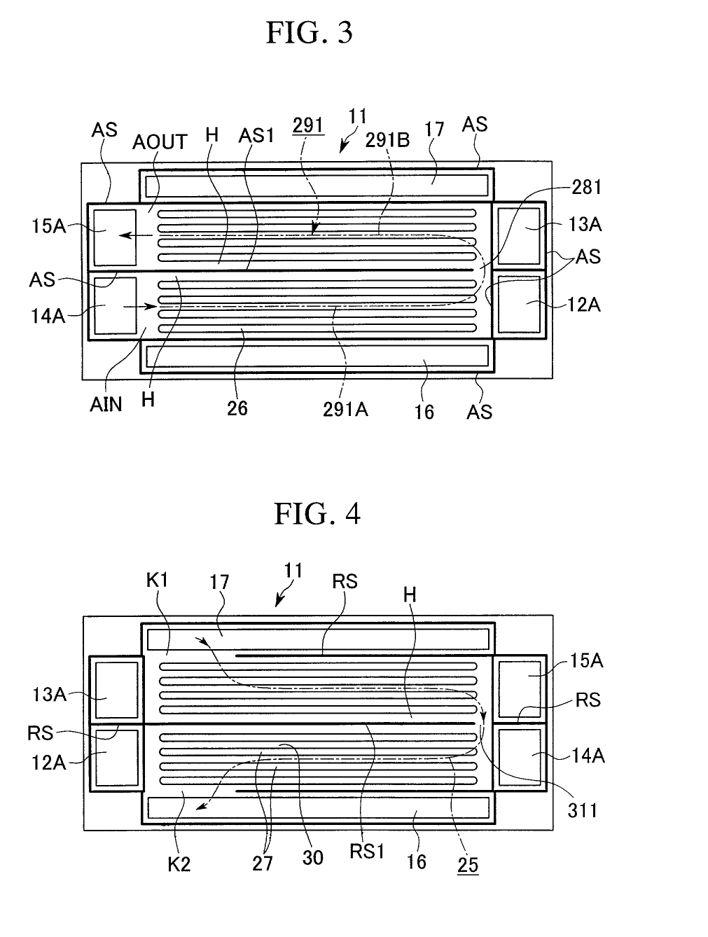

FIG. 3 shows an anode side separator 11 press-formed from a metal material such as a stainless steel sheet material, as with the cathode side separator 10 shown in FIG. 1, and clamps the membrane electrode assembly at a position facing the cathode side separator 10.

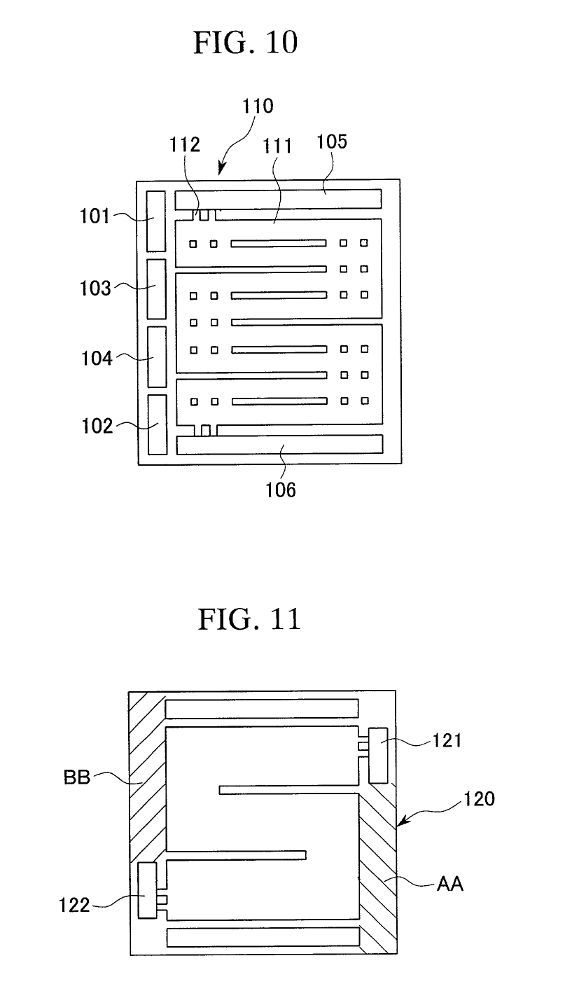

In the anode side separator 11, there are formed corresponding to the cathode side separator 10, two communicating hole 12A and 13A at the right side edge corresponding to the left side edge of the cathode side separator 10, and two communicating holes 14A and 15A at the left side edge corresponding to the right side edge of the cathode side separator 10. Moreover, at the upper side edge and the lower side edge, there is respectively formed one communicating hole 16, 17. As with the cathode side separator 10 shown in FIG. 10, this results in an internal manifold type.

Specifically, the inlet side communicating hole 12A for an oxidant gas is formed on the lower side of the right side edge of the anode side separator 11, and the outlet side communicating hole 13A for the oxidant gas is formed at the upper side of the right side edge. On the other hand, the inlet side communicating hole 14A for a fuel gas (fuel gas inlet) is formed on the lower side of the left side edge of the anode side separator 11, and the outlet side communicating hole 15A for the fuel gas (fuel gas outlet) is formed in the upper side of the left side edge.

Moreover, the outlet side communicating hole (coolant outlet) 16 for the coolant is formed at the lower side edge of the anode side separator 11, and the inlet side communicating hole (coolant inlet) 17 for the coolant is formed at the upper side edge thereof.

The portion surrounded by the respective communicating holes 12A and 13A for the oxidant gas, the respective communicating holes 14A and 15A for the fuel gas, and the respective communicating holes 17 and 16 for the coolant is constructed as a rectangular gas channel surface which face the anode electrode and to which the fuel gas is supplied.

On the gas channel sufrace, corresponding to the cathode side separator 10, there are provided a plurality of grooves (sub-channels) 26 extending linearly in the lateral direction in units of four grooves by press forming. Here, the grooves 26 are concave portions of the portions formed in a corrugation, and on the backside of the anode side separator 11 shown in FIG. 4, these are formed as protruding members 27.

The end portion on the right of each groove 26 is arranged with a predetermined space from the left side edge position of each communicating hole 12A and 13A for the oxidant gas, and the end portion on the left of each groove 26 is arranged with a predetermined space from the right side edge position of each communicating hole 14A and 15A for the fuel gas.

Referring to FIG. 3, the peripheries of the inlet side communicating holes 12A and the outlet side communicating hole 13A for the fuel gas, and the inlet side communicating hole 17 and the outlet side communicating hole 16 for the coolant are surrounded by a sealing member AS, respectively.

The inlet side communicating hole 14A and the outlet side communicating hole 15A for the fuel gas are also surrounded by the sealing member AS, with the exception of the right side edge thereof.

That is to say, the inlet side communicating hole 14A and the outlet side communicating hole 15A for the fuel gas are communicated with the gas channel surface at the right side edge, respectively.

A sealing member AS is provided between the inlet side communicating hole 14A and the outlet side communicating hole 15A for the fuel gas. This sealing member AS extends between the grooves 26 on the reaction plane without a seam, and has an extended portion AS1 reaching to the vicinity of the right side end portions of the grooves 26. The sealing member AS and the extended portion AS1 are attached by injection, baking, bonding or the like.

Here, the spaces between the grooves 26 where the extended portion AS1 is provided means the spaces between respective units of the grooves 26 formed in units as described above, and these portions are flat surfaces H where the press forming is not performed.

Here, a space for forming a connecting path (turning portion) 281 is ensured between the right side end portion of the extended portion AS1 and the sealing member AS arranged at a position facing this extended portion AS1. The connecting path 281 serves as a buffer for collecting the reaction gas upstream. The end of the groove 26 in the side of the inlet side communicating hole 14A is a gas channel inlet AIN, and the end of the groove 26 in the side of the outlet side communicating hole 15A is a gas channel outlet AOUT. The gas channel inlet AIN and the gas channel outlet AOUT serve as a part of the buffer.

As a result, on the gas channel surface of the anode side separator 11, there are formed a U-shaped gas channel (fuel gas channel) 291 with the extended portion AS1 being the boundary portion, and the connecting path 281 being the turning portion.

That is, the U-shaped gas channel 291 comprises a first route 291A from the gas channel inlet AIN in the side of the inlet side communicating hole 14A to the communicating path 281 as the turning portion, and a second returning route 291B from the communicating path 281 to the gas channel outlet AOUT in the side of the outlet side communicating hole 15C.

The gas channel inlet CIN of the cathode side separator 10 is located at the communicating path 281 of the gas channel 291 provided on the anode side separator 11. The gas channel inlet AIN of the anode side separator 11 is located at the communicating path 201 of the gas channel 211 provided on the cathode side separator 10.

FIG. 4 shows the anode side separator 11 in FIG. 3 as seen from the backside. Therefore, the right side edge in FIG. 4 corresponds to the left side edge in FIG. 3, and the left side edge in FIG. 4 corresponds to the right side edge in FIG. 3. Specifically, the inlet side communicating hole 12A for the oxidant gas is formed on the lower side of the left side edge thereof, and the outlet side communicating hole 13A for the oxidant gas is formed at the upper side of the left side edge. Also, the inlet side communicating hole 14A for the fuel gas is formed on the lower side of the right side edge thereof, and the outlet side communicating hole 15A for the fuel gas is formed at the upper side of the right side edge.

Moreover, the outlet side communicating hole 16 for the coolant is formed at the lower side edge of the anode side separator 11, and the inlet side communicating hole 17 for the coolant is formed at the upper side edge thereof, as in FIG. 3.

The portion surrounded by the communicating hole 12A and 13A for the oxidant gas, the communicating holes 14A and 15A for the fuel gas, and the communicating holes 17 and 16 for the coolant is constructed as a cooling plane to which the coolant is supplied.

On the cooling plane, there are formed protruding members 27 at positions corresponding to the grooves 26 described referring to FIG. 3. Therefore, these protruding members 27 are formed in units of four ribs, similarly to the grooves 26. Here, the protruding members 27 are convex portions of the portions formed in a corrugation. Therefore, grooves 30 are formed between adjacent protruding members 27. The end portion on the left of each protruding member 27 is arranged with a predetermined space from the right side edge position of each communicating hole 12A and 13A for the oxidant gas, and the end portion on the right of each protruding member 27 is arranged with a predetermined space from the left side edge position of each communicating hole 14A and 15A for the fuel gas.

Referring to FIG. 4, the peripheries of the inlet side communicating holes 12A and the outlet side communicating hole 13A for the oxidant gas, the inlet side communicating holes 14A and the outlet side communicating hole 15A for the fuel gas are surrounded by a sealing member RS, respectively.

The periphery of the outlet side communicating hole 16 for the coolant is also surrounded by the sealing member RS, with the exception of the portion where a part of the cooling plane side (the left side in FIG. 4) is excised as a notch portion K2.

On the other hand, the periphery of the inlet side communicating hole 17 for the coolant is surrounded by the sealing member RS, with the exception of the portion where a part of the cooling plane side (the left side in FIG. 4) is excised as a notch portion K1.

The inlet side communicating hole 17 for the coolant is communicated with the cooling plane in the notch portion K1, and the outlet side communicating hole 16 is communicated with the cooling plane in the notch portion K2.

A sealing member RS is provided between the inlet side communicating hole 12A and the outlet side communicating hole 13A for the oxidant gas. This sealing member RS extends between the protruding members 27 on the cooling plane without a seam, and has an extended portion RS1 reaching to the vicinity of the right side end portions of the protruding members 27.

The sealing member RS and the extended portion RS1 are attached by injection, baking, bonding or the like.

Here, the spaces between protruding members 27 where the extended portion RS1 is provided means the spaces between respective units of the protruding members 27 formed in units as described above, and these portions are flat surfaces H where the press forming is not performed.

Here, a space for forming a connecting path 311 is ensured between the right side end portion of the extended portion RS1 and the sealing member RS arranged at a position facing this extended portion RS1.

As a result, on the cooling plane of the anode side separator 11, there is formed a meandering coolant channel 25 with the extended portion RS1 being the boundary portion, and the connecting path 311 being the turning portion.

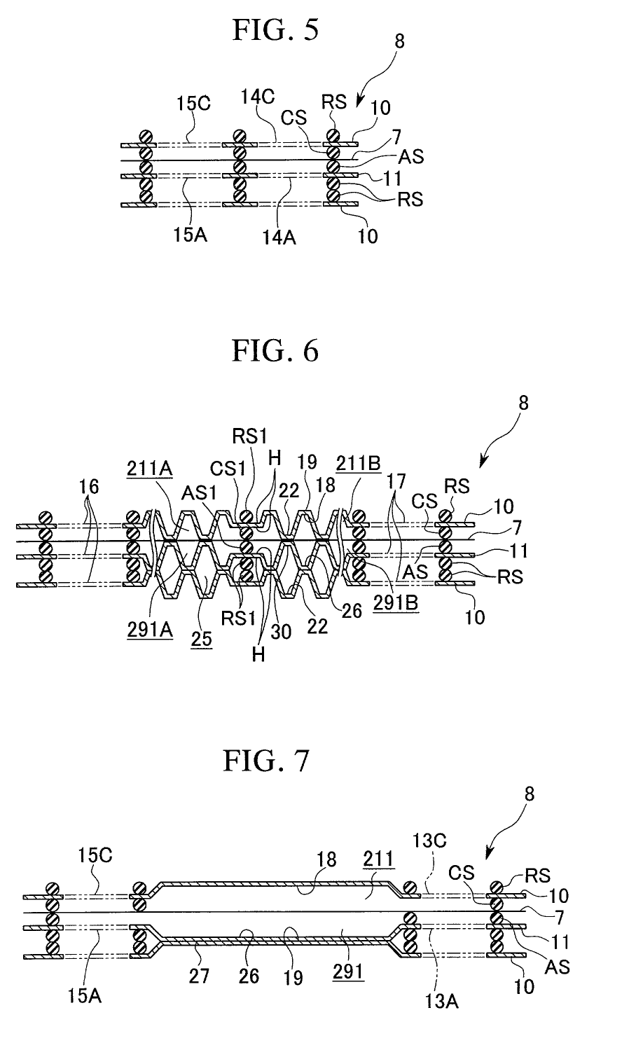

FIG. 5 to FIG. 9 show in cross-section for each part of FIG. 2, a fuel cell 8 constructed such that a membrane electrode assembly 7 is clamped by the cathode side separator 10 and the anode side separator 11.

FIG. 5 is a cross-section along the line A-A in FIG. 2. In this figure, the membrane electrode assembly 7 is constituted by a solid polymer electrolyte membrane, with an anode and an cathode provided at opposite positions on both sides of the solid polymer electrolyte membrane, and the membrane electrode assembly 7 is clamped by the cathode side separator 10 and the anode side separator 11 via the sealing members CS and AS.

In this case, the inlet side communicating holes 12C and the outlet side communicating hole 13C for the oxidant gas in the cathode side separator 10 in FIG. 1 match with the inlet side communicating holes 12A and the outlet side communicating hole 13A for the oxidant gas in the anode side separator 11 in FIG. 3. Also, the inlet side communicating holes 14C and the outlet side communicating hole 15C for the fuel gas in the cathode side separator 10 in FIG. 1 match with the inlet side communicating hole 14A and the outlet side communicating hole 15A for the fuel gas in the anode side separator 11 in FIG. 3. The membrane electrode assembly 7 is clamped therebetween on the reaction plane, with each part matching to each other.

Moreover, since the cathode side separator 10 and the anode side separator 11 clamping the membrane electrode assembly 7 are laminated in a plurality of numbers, each cooling plane faces each other at an adjoining portion. That is to say, the inlet side communicating hole 12C and the outlet side communicating hole 13C for the oxidant gas in the cathode side separator 10 in FIG. 2 match with the inlet side communicating holes 12A and the outlet side communicating hole 13A for the oxidant gas in the anode side separator 11 in FIG. 4. On the other hand, the inlet side communicating holes 14C and the outlet side communicating hole 15C for the fuel gas in the cathode side separator 10 in FIG. 2 match with the inlet side communicating hole 14A and the outlet side communicating hole 15A for the fuel gas in the anode side separator 11 in FIG. 4.

In a condition with these separators laminated in this manner, the above described gas channel 211 is formed between the cathode side separator 10 and the membrane electrode assembly 7, and the above described gas channels 291 is formed between the anode side separator 11 and the membrane electrode assembly 7, and the above described coolant channel 25 is formed between the anode side separator 11 and the cathode side separator 10.

Moreover, as shown in FIG. 5, the inlet side communicating hole 14C and the outlet side communicating hole 15C for the fuel gas in the cathode side separator 10 are sealed by the sealing member CS together with the inlet side communicating holes 14A and the outlet side communicating hole 15A for the fuel gas in the anode side separator 11.

FIG. 6 is a cross-section along the line B-B in FIG. 2. In this figure, the extended portions RS1 of the sealing members RS are in close contact with each other, in order to form the coolant channel 25 meandering between the cooling plane of the cathode side separator 10 and the cooling plane of the anode side separator 11. Also, the protruding members on the gas channel surface of the cathode side separator 10 and on the gas channel surface of the anode side separator 11 (the backsides of the grooves 22 and the grooves 30) clamp the membrane electrode assembly 7 therebetween, and the grooves 22 on the cooling plane of the cathode side separator 10 and the grooves 30 on the cooling plane of the anode side separator 11 face each other to thereby form the coolant channel 25.

Furthermore, FIG. 7 is a cross-section along the line C-C in FIG. 2. This figure shows the condition where the grooves 18 on the gas channel surface of the cathode side separator 10 and the grooves 26 on the gas channel surface of the anode side separator 11 form the gas channels 211 and 291 between the membrane electrode assembly 7 and those separators, respectively, and the condition where the protruding members 19 on the cooling plane of the cathode side separator 10 and the protruding members 27 on the cooling plane of the anode side separator 11 are located closely to partition the coolant channel.

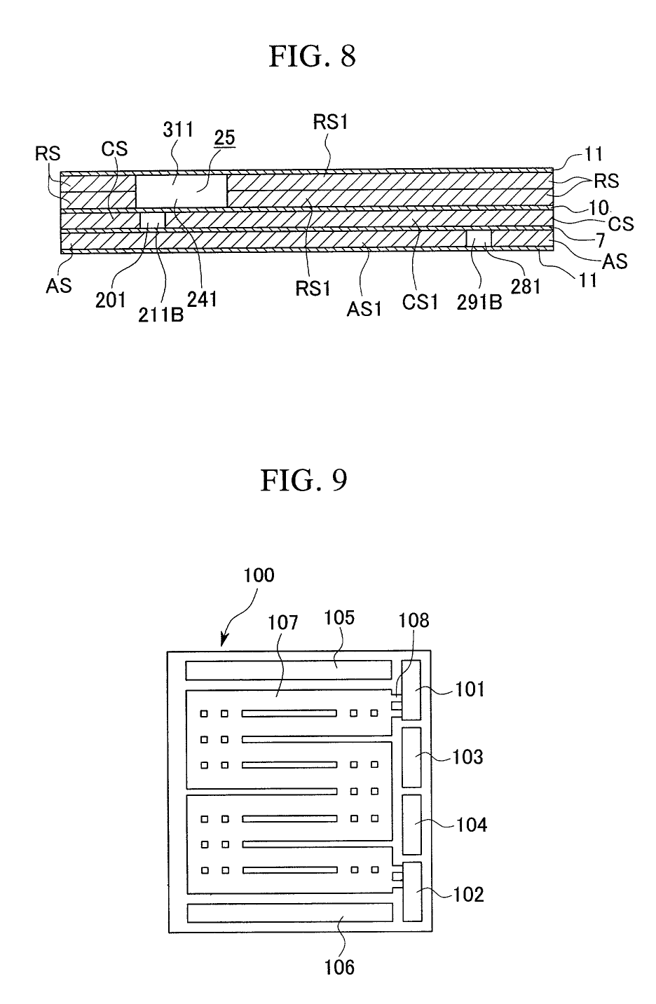

FIG. 8 is a cross-section along the line D-D in FIG. 2, showing the condition where each sealing member AS, CS, RS is located closely to each other, including the respective extended portions AS2, CS2 and RS2.

In the above described embodiment, when the oxidant gas is supplied to the fuel cell 8, this oxidant gas is supplied, as shown in FIG. 1, from the inlet side communicating hole 12C for the oxidant gas in the cathode side separator 10 to the gas channel surface of the cathode side separator 10.

Then, the oxidant gas flows into the U-shaped gas channel 211 having the extended portion CS1 as the boundary portion and the connecting path 201 as the turning portion, and the reacted gas is exhausted from the outlet side communicating hole 13C for the oxidant gas.

On the other hand, in a similar manner, when the fuel gas is supplied to the fuel cell, this fuel gas is supplied, as shown in FIG. 3, from the inlet side communicating hole 14A for the fuel gas in the anode side separator 11 to the gas channel surface of the anode side separator 11.

Then, the fuel gas flows into the U-shaped reactant gas channel 291 having the extended portion AS1 as the boundary portion and the connecting path 281 as the turning portion, and the reacted gas is exhausted from the outlet side communicating hole 15A for the fuel gas.

As a result, by the supplied fuel gas and oxidant gas, electric energy is generated between the cathode side separator 10 and the anode side separator 11 via the solid polymer electrolyte membrane, to thereby generate power.

Furthermore, when the coolant is supplied to the fuel cell, this coolant is supplied, as shown in FIG. 2 and FIG. 4, from the inlet side communicating hole 17 for the coolant in the cathode side separator 10 and the anode side separator 11 to the cooling plane of each separator 10, 11.

Then, the coolant flows into the meandering coolant channel 25 having the extended portion RS1 as the boundary portion and the connecting paths 241 and 311 as the turning portion, and is exhausted from the outlet side communicating hole 16 for the coolant.

As a result, the fuel cell can be cooled.

As described above, in the embodiment, the inlet side communicating holes 12C and 14A for the reaction gas, and the outlet side communicating holes 13C and 15A are provided in the side edges of the cathode side separator 10 and the anode side separator 11 facing each other. Therefore, the condensed water, which is increased as the gas flows from the inlet side communicating holes 12C and 14A via the communicating paths 201 and 281 as the turning portion to the outlet side communicating holes 13C and 15A, causes back-diffusion from the cathode side to the anode side, and moves to the other separator side.

Thus, the reaction gas can be sufficiently humidified, facilitating the reaction, and therefore the humidification device and its related equipment can be made smaller and can be simplified.

In addition to this construction in the embodiment, the inlet side communicating hole 17 and the outlet side communicating hole 16 for the coolant are provided in the upper side and the lower side of the cathode side separator 10 and the anode side separator 11. The communicating holes 16 and 17 are long openings extending from side to side of the separators 10 and 11. Therefore, the widths of the openings can be reduced while the necessary amount of the coolant can be ensured, and the height of the device to which this invention is applied can be reduced.

For example, the design layout of the fuel cell provided in a thin space such as a space under a car floor, or under a car trunk is possible.

The communicating path 201 of the cathode side separator 10 and the connecting path 281 of the anode side separator 11 serve as a part of the buffer for collecting the reaction gas from the first routes 211A and 291A. On the other hand, the gas channel inlet CIN and the gas channel outlet COUT of the cathode side separator 10 serve as a part of the buffer for the inlet side communicating holes 12C and the outlet side communicating hole 13C for the oxidant gas. The gas channel inlet AIN and the gas channel outlet AOUT of the anode side separator 11 serve as a part of the buffer for the inlet side communicating hole 14A and the outlet side communicating hole 15A for the fuel gas.

Even if the condensed water blocks a part of the grooves 18 and 26, the buffer introduces the reaction gas into the grooves which are not blocked. In this case, the effective reaction area is not significantly reduced as compared with the device which has continuous gas channels without any communicating path.

The present invention is not limited to the above described embodiments, and for example, the present invention is applicable to a molten carbonate type fuel cell other than the solid polymer type fuel cell.

While the metal separators manufactured by press-forming is described, the present invention is applicable to a separator made of molded carbon material, and to a separator with grooves formed by cutting a carbon plate.

Further, while in the embodiment the sealing member extends so as to form the gas channels, the gas channels may be formed by combining the sealing member to the ribs.

The present invention is not limited to the embodiment in which a part of the gas channel is formed by the sealing member, and is applicable to an embodiment in which the gas channels are manufactured by press-forming.

This invention may be embodied in other forms or carried out in other ways without departing from the spirit thereof. The present embodiments are therefore to be considered in all respects illustrative and not limiting, the scope of the invention being indicated by the appended claims, and all modifications falling within the meaning and range of equivalency are intended to be embraced therein.

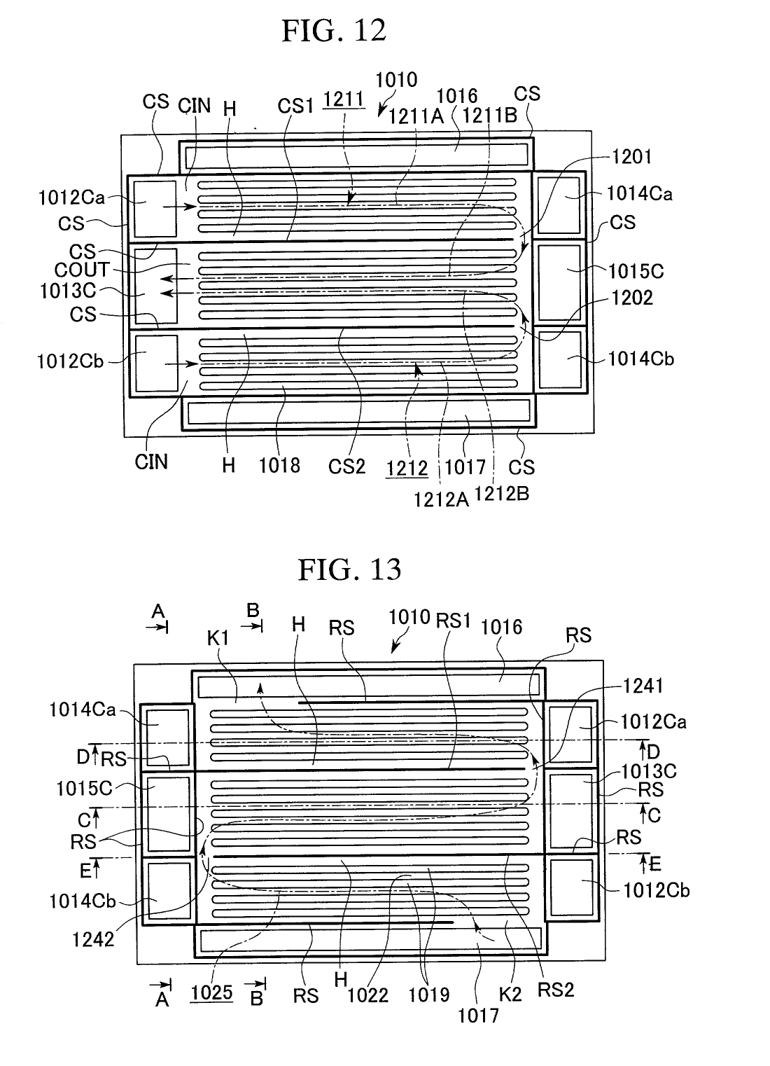

Embodiments of the present invention will now be described with reference to the drawings. FIG. 12 to FIG. 20 show a second embodiment of the invention.

FIG. 12 shows a cathode side separator (gas channel plate) 1010 which is press-formed from a metal material such as a stainless steel sheet material. The cathode side separator 101010 clamps a membrane electrode assembly together with an anode side separator (gas channel plate) 1011 described later, to thereby constitute a fuel cell. These are further laminated in a plurality of sets in the horizontal direction, to thereby constitute a fuel cell stack mounted on, for example, vehicles.

In the cathode side separator 101010, there are formed three communicating holes 1012Ca, 1013C and 1012Cb at the left side edge, and three communicating holes 1014Ca, 1015C and 1014Cb at the right side edge, respectively. At the upper side edge and the lower side edge, there is respectively formed one communicating hole 1016, 1017. That is to say, this embodiment is a so-called internal manifold type.

Specifically, the inlet side communicating holes 1012Ca and 1012Cb for an oxidant gas (for example, air) are respectively formed on the upper side and the lower side of the left side edge of the cathode side separator 101010, and the outlet side communicating hole 1013C for the oxidant gas is formed in the center of the left side edge. On the other hand, the inlet side communicating holes 1014Ca and 1014Cb for a fuel gas (for example, hydrogen containing gas) are respectively formed on the upper side and the lower side of the right side edge of the cathode side separator 101010, and the outlet side communicating hole 1015C for the fuel gas is formed in the center of the right side edge.

Moreover, the outlet side communicating hole 1016 for a coolant (for example, ethylene glycol) is formed at the upper side edge of the cathode side separator 101010, and the inlet side communicating hole 1017 for the coolant is formed at the lower side edge thereof.

The portion surrounded by the respective communicating holes 1012Ca, 1012Cb and 1013C for the oxidant gas, the respective communicating holes 1014Ca, 1014Cb and 1015C for the fuel gas, and the respective communicating holes 1017 and 1016 for the coolant is constructed as a rectangular gas channel surface to which the oxidant gas is supplied.

On the gas channel surface, there are provided a plurality of grooves 1018 extending linearly in the lateral direction in units of several grooves (four, five and four from the top) by press forming. Here, the grooves 1018 are concave portions of the portions formed in a corrugation, and on the backside of the cathode side separator 101010 shown in FIG. 13, these are formed as protruding members 1019.

The end portion on the left of each groove 1018 is arranged with a predetermined space from the right side edge position of each communicating hole 1012Ca, 1012Cb and 1013C for the oxidant gas, and the end portion on the right of each groove 1018 is arranged with a predetermined space from the left side edge position of each communicating hole 1014Ca, 1014Cb and 1015C for the fuel gas.

Referring to FIG. 12, the peripheries of the inlet side communicating holes 1014Ca and 1014Cb and the outlet side communicating hole 1015C for the fuel gas, and the inlet side communicating hole 1017 and the outlet side communicating hole 1016 for the coolant are surrounded by a sealing member CS, respectively.

Moreover, the inlet side communicating holes 1012Ca and 1012Cb and the outlet side communicating hole 1013C for the oxidant gas are surrounded by the sealing member CS, with the exception of the right side edge thereof.

That is to say, the inlet side communicating holes 1012Ca and 1012Cb and the outlet side communicating hole 1013C for the oxidant gas are communicated with the reaction plane at the right side edge, respectively.

A sealing member CS is provided between the inlet side communicating hole 1012Ca and the outlet side communicating hole 1013C for the oxidant gas. This sealing member CS extends between the grooves 1018 on the reaction plane without a seam, and has an extended portion CS1 reaching to the vicinity of the right side end portions of the grooves 1018.

Moreover, a sealing member CS is provided between the inlet side communicating hole 1012Cb and the outlet side communicating hole 1013C for the oxidant gas, and this sealing member CS extends between the grooves 1018 on the gas channel surface without a seam, and has an extended portion CS2 reaching to the vicinity of the right side end portions of the grooves 1018. The sealing member CS and the extended portions CS1 and CS2 are attached by injection, baking, bonding or the like.

Here, the spaces between the grooves 1018 where the extended portions CS1 and CS2 are provided means the spaces between respective units of the grooves 1018 formed in units as described above, and these portions are flat surfaces H where the press forming is not performed.

Here, a space for forming a connecting path 201 is ensured between the right side end portion of the extended portion CS1 and the sealing member CS arranged at a position facing this extended portion CS1. Moreover, a space for forming a connecting path 202 is ensured between the right side end portion of the extended portion CS2 and the sealing member CS arranged at a position facing this extended portion CS2. The communicating paths 201 and 202 acts as a part of a buffer for collecting the reaction gas upstream. The end of the groove 18 in the side of the inlet side communicating hole 12Ca is a gas channel inlet CIN, the end of the groove 18 in the side of the outlet side communicating hole 13C is a gas channel outlet COUT. The gas channel inlet CIN and the gas channel outlet COUT act as a part of the buffer.

As a result, on the gas channel surface of the cathode side separator 1010, there are formed a U-shaped reactant gas (oxidant gas) channel 211 with the extended portion CS1 being the boundary portion, and the connecting path 201 being the turning portion, and a U-shaped reactant gas channel 212 with the extended portion CS2 being the boundary portion, and the connecting path 202 being the turning portion.

That is, the U-shaped gas channel 211 comprises a first route 211A from the gas channel inlet CIN in the side of the inlet side communicating hole 12Ca to the communicating path 201 as the turning portion, and a second returning route 211B from the communicating path 201 to the gas channel outlet COUT in the side of the outlet side communicating hole 13C. The U-shaped gas channel 212 comprises a first route 212A from the gas channel inlet CIN in the side of the inlet side communicating hole 12Cb to the communicating path 202 as the turning portion, and a second returning route 212B from the communicating path 202 to the gas channel outlet COUT in the side of the outlet side communicating hole 13C.

A pair of gas channels 211 and 212 are provided on the gas channel surface of the cathode side separator 1010. The returning route 211B and 212B of the gas channels 211 and 212 merge.

On the other hand, FIG. 13 shows the cathode side separator 1010 in FIG. 12 as seen from the backside. Therefore, the right side edge in FIG. 13 corresponds to the left side edge in FIG. 12, and the left side edge in FIG. 13 corresponds to the right side edge in FIG. 12. Specifically, the inlet side communicating holes 12Ca and 12Cb for the oxidant gas are respectively formed on the upper side and the lower side of the right side edge thereof, and the outlet side communicating hole 13C for the oxidant gas is formed in the center of the right side edge. Also, the inlet side communicating holes 14Ca and 14Cb for the fuel gas are respectively formed on the upper side and the lower side of the left side edge thereof, and the outlet side communicating hole 15C for the fuel gas is formed in the center of the left side edge.

Moreover, the outlet side communicating hole 16 for the coolant is formed at the upper side edge of the cathode side separator 1010, and the inlet side communicating hole 17 for the coolant is formed at the lower side edge thereof, as in FIG. 12.

The portion surrounded by the respective communicating holes 12Ca, 12Cb and 13C for the oxidant gas, the respective communicating holes 14Ca, 14Cb and 15C for the fuel gas, and the respective communicating holes 17 and 16 for the coolant is constructed as a cooling plane to which the coolant is supplied.

On the cooling plane, there are formed protruding members 1019 at positions corresponding to the grooves 1018 described referring to FIG. 12. Therefore, these protruding members 1019 are formed in units of several ribs (four, five and four from the top), similarly to the grooves 1018. Here, the protruding members 1019 are convex portions of the portions formed in a corrugation. Therefore, grooves 1022 are formed between adjacent protruding members 1019.

The end portion on the right of each protruding member 1019 is arranged with a predetermined space from the left side edge position of each communicating hole 1012Ca, 1012Cb, 1013C for the oxidant gas, and the end portion on the left of each protruding member 1019 is arranged with a predetermined space from the right side edge position of each communicating hole 1014Ca, 1014Cb and 1015C for the fuel gas.

Referring to FIG. 13, the peripheries of the inlet side communicating holes 1012Ca and 1012Cb and the outlet side communicating hole 1013C for the oxidant gas, the inlet side communicating holes 1014Ca and 1014Cb and the outlet side communicating hole 1015C for the fuel gas are surrounded by a sealing member RS, respectively.

The periphery of the outlet side communicating hole 1016 for the coolant is also surrounded by the sealing member RS, with the exception of the portion where a part of the cooling plane side (the left side in FIG. 13) is excised as a notch portion K1. Moreover, the periphery of the inlet side communicating hole 1017 for the coolant is surrounded by the sealing member RS, with the exception of the portion where a part of the cooling plane side (the right side in FIG. 13) is excised as a notch portion K2.

That is to say, the inlet side communicating hole 1017 for the coolant is communicated with the cooling plane in the notch portion K2, and the outlet side communicating hole 16 is communicated with the cooling plane in the notch portion K1.

A sealing member RS is provided between the inlet side communicating hole 1014Ca and the outlet side communicating hole 1015C for the fuel gas. This sealing member RS extends between the protruding members 1019 on the cooling plane without a seam, and has an extended portion RS1 reaching to the vicinity of the right side end portions of the protruding members 1019.

Moreover, a sealing member RS is provided between the inlet side communicating hole 1012Cb and the outlet side communicating hole 1013C for the oxidant gas, and this sealing member RS extends between the protruding members 1019 on the cooling plane without a seam, and has an extended portion RS2 reaching to the vicinity of the left side end portions of the protruding members 1019. The sealing member RS and the extended portions RS1 and RS2 are attached by injection, baking, bonding or the like.

Here, the spaces between protruding members 1019 where the extended portions RS1 and RS2 are provided means the spaces between respective units of the protruding members 1019 formed in units as described above, and these portions are flat surfaces H where the press forming is not performed.

Here, a space for forming a connecting path 1241 is ensured between the right side end portion of the extended portion RS1 and the sealing member RS arranged at a position facing this extended portion RS1. Moreover, a space for forming a connecting path 1242 is also ensured between the left side end portion of the extended portion RS2 and the sealing member RS arranged at a position facing this extended portion RS2.

As a result, on the cooling plane of the cathode side separator 1010, there is formed a meandering coolant channel 1025 with the extended portion RS2 and the extended portion RS1 being the boundary portion, and the two connecting paths 1242 and 1241 being the turning portion.

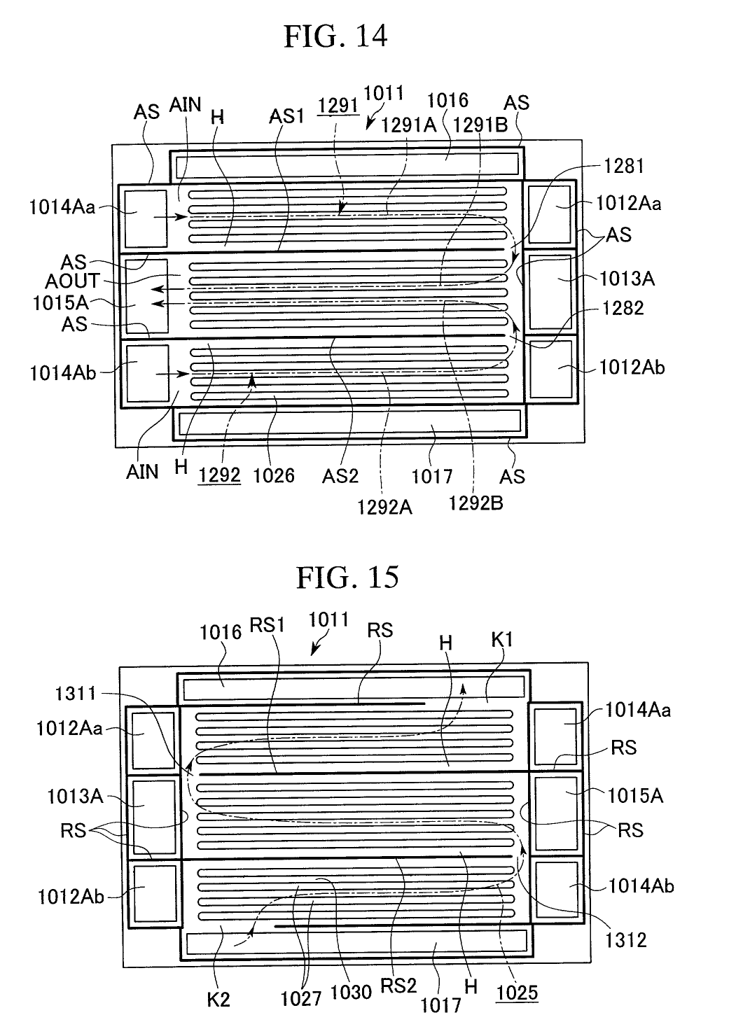

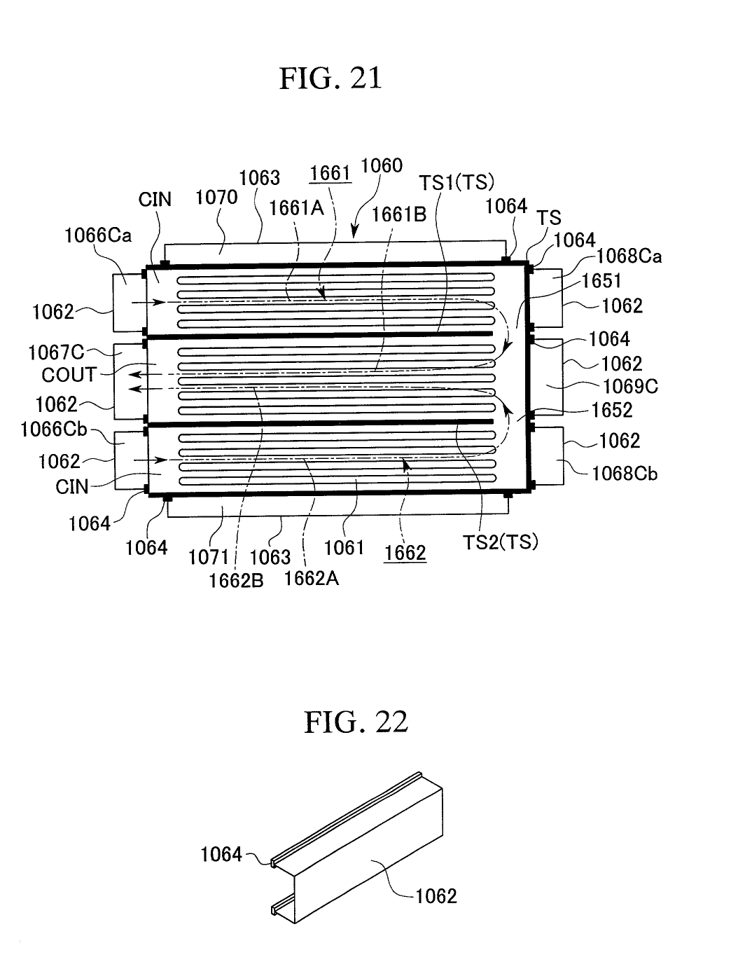

FIG. 14 shows an anode side separator 1011 press-formed from a metal material such as a stainless steel sheet material, as with the cathode side separator 1010 shown in FIG. 12, and clamps the membrane electrode assembly at a position facing the cathode side separator 1010. In the anode side separator 1011, there are formed corresponding to the cathode side separator 1010, three communicating holes 1012Aa, 1013A and 1012Ab at the left side edge, and three communicating holes 1014Aa, 1015A and 1014Ab at the right side edge. Moreover, at the upper side edge and the lower side edge, there is respectively formed one communicating hole 1016, 1017. As with the cathode side separator 1010 shown in FIG. 21, this results in an internal manifold type.

Specifically, the inlet side communicating holes 1012Aa and 1012Ab for an oxidant gas are respectively formed on the upper side and the lower side of the left side edge of the anode side separator 1011, and the outlet side communicating hole 1013A for the oxidant gas is formed in the center of the right side edge. On the other hand, the inlet side communicating holes 1014Aa and 1014Ab for a fuel gas are respectively formed on the upper side and the lower side of the left side edge of the anode side separator 1011, and the outlet side communicating hole 1015A for the fuel gas is formed in the center of the left side edge.

Moreover, the outlet side communicating hole 1016 for the coolant is formed at the upper side edge of the anode side separator 1011, and the inlet side communicating hole 1017 for the coolant is formed at the lower side edge thereof.

The portion surrounded by the respective communicating holes 1012Aa, 1012Ab and 1013A for the oxidant gas, the respective communicating holes 1014Aa, 1014Ab and 1015A for the fuel gas, and the respective communicating holes 1017 and 1016 for the coolant is constructed as a rectangular gas channel surface to which the fuel gas is supplied.

On the gas channel surface, corresponding to the cathode side separator 1010, there are provided a plurality of grooves 1026 extending linearly in the lateral direction in units of several grooves (four, five and four from the top) by press forming. Here, the grooves 1026 are concave portions of the portions formed in a corrugation, and on the backside of the anode side separator 1011 shown in FIG. 15, these are formed as protruding members 1027.

The end portion on the right of each groove 1026 is arranged with a predetermined space from the left side edge position of each communicating hole 1012Aa, 1012Ab and 1013A for the oxidant gas, and the end portion on the left of each groove 1026 is arranged with a predetermined space from the right side edge position of each communicating hole 1014Aa, 1014Ab and 1015A for the fuel gas.

Referring to FIG. 14, the peripheries of the inlet side communicating holes 1012Aa and 1012Ab and the outlet side communicating hole 1013A for the fuel gas, and the inlet side communicating hole 1017 and the outlet side communicating hole 1016 for the coolant are surrounded by a sealing member AS, respectively.

The inlet side communicating holes 14Aa and 14Ab and the outlet side communicating hole 15A for the fuel gas are also surrounded by the sealing member AS, with the exception of the right side edge thereof.

That is to say, the inlet side communicating holes 1014Aa and 1014Ab and the outlet side communicating hole 1015A for the fuel gas are communicated with the reaction plane at the right side edge, respectively.

A sealing member AS is provided between the inlet side communicating hole 14Aa and the outlet side communicating hole 1015A for the fuel gas. This sealing member AS extends between the grooves 1026 on the reaction plane without a seam, and has an extended portion AS1 reaching to the vicinity of the right side end portions of the grooves 1026.

Moreover, a sealing member AS is provided between the inlet side communicating hole 1014Ab and the outlet side communicating hole 1015A for the fuel gas, and this sealing member AS extends between the grooves 1026 on the reaction plane without a seam, and has an extended portion AS2 reaching to the vicinity of the right side end portions of the grooves 1026. The sealing member AS and the extended portions AS1 and AS2 are attached by injection, baking, bonding or the like.

Here, the spaces between the grooves 1026 where the extended portions AS1 and AS2 are provided means the spaces between respective units of the grooves 1026 formed in units as described above, and these portions are flat surfaces H where the press forming is not performed.

Here, a space for forming a connecting path 1281 is ensured between the right side end portion of the extended portion AS1 and the sealing member AS arranged at a position facing this extended portion AS1. A space for forming a connecting path 1282 is also ensured between the right side end portion of the extended portion AS2 and the sealing member AS arranged at a position facing this extended portion AS2. The connecting paths 1281 and 1282 serve as a part of the buffer for collecting the reaction gas upstream. The end of the groove 1026 in the side of the inlet side communicating hole 1014Aa is a gas channel inlet AIN, and the end of the groove 1026 in the side of the outlet side communicating hole 1015A is a gas channel outlet AOUT. The gas channel inlet AIN and the gas channel outlet AOUT serve as a part of the buffer.

As a result, on the gas channel surface of the anode side separator 1011, there are formed a U-shaped reactant gas (fuel gas) channel 1291 with the extended portion AS1 being the boundary portion, and the connecting path 1281 being the turning portion, and a U-shaped reactant gas channel 1292 with the extended portion AS2 being the boundary portion, and the connecting path 1282 being the turning portion.

That is, the U-shaped gas channel 1291 comprises a first route 1291A from the gas channel inlet AIN in the side of the inlet side communicating hole 14Aa to the communicating path 1281 as the turning portion, and a second returning route 1291B from the communicating path 1281 to the gas channel outlet AOUT in the side of the outlet side communicating hole 1015A. The U-shaped gas channel 1292 comprises a first route 1292A from the gas channel inlet AIN in the side of the inlet side communicating hole 1014Aa to the communicating path 1282 as the turning portion, and a second returning route 1292B from the communicating path 1282 to the gas channel outlet AOUT in the side of the outlet side communicating hole 1015A.

A pair of gas channels 1291 and 1292 are provided on the gas channel surface of the anode side separator 1011. The returning route 1291B and 1292B of the gas channels 1291 and 1292 merge.

On the other hand, FIG. 15 shows the anode side separator 1011 in FIG. 14 as seen from the backside. Therefore, the right side edge in FIG. 15 corresponds to the left side edge in FIG. 14, and the left side edge in FIG. 15 corresponds to the right side edge in FIG. 14. Specifically, the inlet side communicating holes 1012Aa and 1012Ab for the oxidant gas are respectively formed on the upper side and the lower side of the left side edge thereof, and the outlet side communicating hole 1013A for the oxidant gas is formed in the center of the left side edge. Also, the inlet side communicating holes 1014Aa and 1014Ab for the fuel gas are respectively formed on the upper side and the lower side of the right side edge thereof, and the outlet side communicating hole 1015A for the fuel gas is formed in the center of the right side edge.

Moreover, the outlet side communicating hole 1016 for the coolant is formed at the upper side edge of the anode side separator 1011, and the inlet side communicating hole 1017 for the coolant is formed at the lower side edge thereof, as in FIG. 14.

The portion surrounded by the respective communicating holes 1012Aa, 1012Ab and 1013A for the oxidant gas, the respective communicating holes 1014Aa, 1014Ab and 1015A for the fuel gas, and the respective communicating holes 1017 and 11016 for the coolant is constructed as a cooling plane to which the coolant is supplied.

On the cooling plane, there are formed protruding members 1027 at positions corresponding to the grooves 1026 described referring to FIG. 14. Therefore, these protruding members 1027 are formed in units of several ribs (four, five and four from the top), similarly to the grooves 1026. Here, the protruding members 1027 are convex portions of the portions formed in a corrugation. Therefore, grooves 1030 are formed between adjacent protruding members 1027.

The end portion on the left of each protruding member 1027 is arranged with a predetermined space from the right side edge position of each communicating hole 1012Aa, 1012Ab and 1013A for the oxidant gas, and the end portion on the right of each protruding member 1027 is arranged with a predetermined space from the left side edge position of each communicating hole 1014Aa, 1014Ab and 1015A for the fuel gas.

Referring to FIG. 15, the peripheries of the inlet side communicating holes 1012Aa and 1012Ab and the outlet side communicating hole 1013A for the oxidant gas, the inlet side communicating holes 1014Aa and 1014Ab and the outlet side communicating hole 1015A for the fuel gas are surrounded by a sealing member RS, respectively.

The periphery of the outlet side communicating hole 1016 for the coolant is also surrounded by the sealing member RS, with the exception of the portion where a part of the cooling plane side (the right side in FIG. 15) is excised as a notch portion K1. Moreover, the periphery of the inlet side communicating hole 1017 for the coolant is surrounded by the sealing member RS, with the exception of the portion where a part of the cooling plane side (the left side in FIG. 15) is excised as a notch portion K2.

That is to say, the inlet side communicating hole 1017 for the coolant is communicated with the cooling plane in the notch portion K2, and the outlet side communicating hole 1016 is communicated with the cooling plane in the notch portion K1.

A sealing member RS is provided between the inlet side communicating hole 1014Aa and the outlet side communicating hole 1015A for the fuel gas. This sealing member RS extends between the protruding members 1027 on the cooling plane without a seam, and has an extended portion RS1 reaching to the vicinity of the left side end portions of the protruding members 1027.

Moreover, a sealing member RS is provided between the inlet side communicating hole 1012Ab and the outlet side communicating hole 1013A for the oxidant gas, and this sealing member RS extends between the protruding members 1027 on the cooling plane without a seam, and has an extended portion RS2 reaching to the vicinity of the right side end portions of the protruding members 1027. The sealing member RS and the extended portions RS1 and RS2 are attached by injection, baking, bonding or the like.

Here, the spaces between protruding members 1027 where the extended portions RS1 and RS2 are provided means the spaces between respective units of the protruding members 1027 formed in units as described above, and these portions are flat surfaces H where the press forming is not performed.

Here, a space for forming a connecting path 1311 is ensured between the left side end portion of the extended portion RS1 and the sealing member RS arranged at a position facing this extended portion RS1. Moreover, a space for forming a connecting path 1312 is also ensured between the right side end portion of the extended portion RS2 and the sealing member RS arranged at a position facing this extended portion RS2.

As a result, on the cooling plane of the anode side separator 1011, there is formed a meandering coolant channel 1025 with the extended portion RS2 and the extended portion RS1 being the boundary portion, and the two connecting paths 1312 and 1311 being the turning portion.

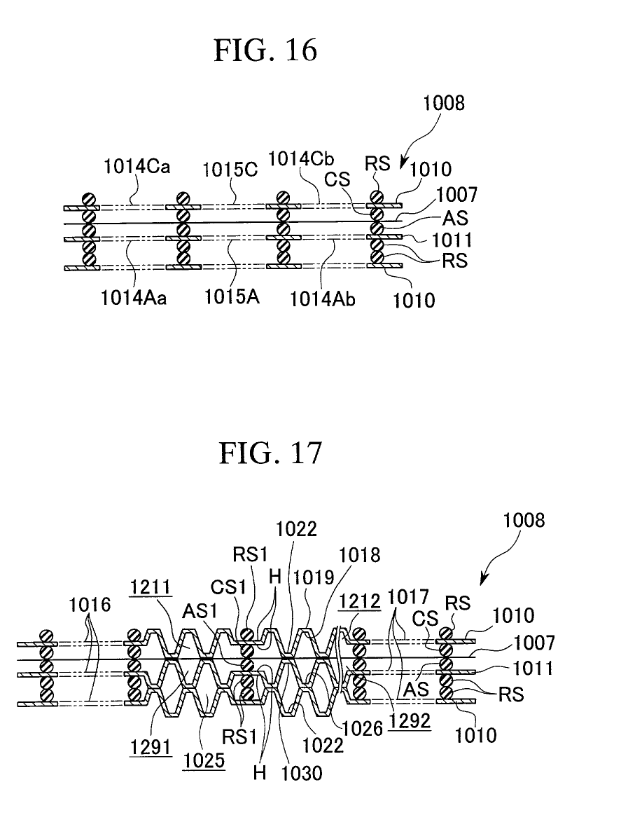

FIG. 16 to FIG. 20 show cross-sections for each part of FIG. 13, a fuel cell 1008 constructed such that a membrane electrode assembly 1007 is clamped by the cathode side separator 1010 and the anode side separator 1011.

FIG. 16 is a cross-section along the line A-A in FIG. 13. In this figure, the membrane electrode assembly 1007 is constituted by a solid polymer electrolyte membrane, with an anode and an cathode provided at opposite positions on both sides of the solid polymer electrolyte membrane, and the membrane electrode assembly 1007 is clamped by the cathode side separator 1010 and the anode side separator 1011 via the sealing members CS and AS.

In this case, the inlet side communicating holes 1012Ca, 1012Cb and the outlet side communicating hole 1013C for the oxidant gas in the cathode side separator 1010 in FIG. 12 match with the inlet side communicating holes 1012Aa, 1012Ab and the outlet side communicating hole 1013A for the oxidant gas in the anode side separator 1011 in FIG. 14. Also, the inlet side communicating holes 1014Ca, 1014Cb and the outlet side communicating hole 1015C for the fuel gas in the cathode side separator 1010 in FIG. 12 match with the inlet side communicating holes 1014Aa, 1014Ab and the outlet side communicating hole 1015A for the fuel gas in the anode side separator 1011 in FIG. 14. The membrane electrode assembly 1007 is clamped therebetween on the reaction plane, with each part matching to each other.

Moreover, since the cathode side separator 1010 and the anode side separator 1011 clamping the membrane electrode assembly 1007 are laminated in a plurality of numbers, each cooling plane faces each other at an adjoining portion. That is to say, the inlet side communicating holes 1012Ca, 1012Cb and the outlet side communicating hole 1013C for the oxidant gas in the cathode side separator 1010 in FIG. 1013 match with the inlet side communicating holes 1012Aa, 1012Ab and the outlet side communicating hole 1013A for the oxidant gas in the anode side separator 1011 in FIG. 15. On the other hand, the inlet side communicating holes 1014Ca and 1014Cb and the outlet side communicating hole 1015C for the fuel gas in the cathode side separator 1010 in FIG. 13 match with the inlet side communicating holes 1014Aa and 1014Ab and the outlet side communicating hole 1015A for the fuel gas in the anode side separator 1101 in FIG. 15.

In a condition with these separators laminated in this manner, the above described reactant gas (oxidant gas) channels 1211 and 1212 are formed between the cathode side separator 1010 and the membrane electrode assembly 1007, and the above described reactant gas (fuel gas) channels 1291 and 1292 are formed between the anode side separator 1011 and the membrane electrode assembly 1007, and the above described coolant channel 1025 is formed between the anode side separator 1011 and the cathode side separator 1010.

Moreover, as shown in FIG. 16, the inlet side communicating holes 1014Ca and 1014Cb and the outlet side communicating hole 1015C for the fuel gas in the cathode side separator 1010 are sealed by the sealing member CS together with the inlet side communicating holes 1014Aa and 1014Ab and the outlet side communicating hole 1015A for the fuel gas in the anode side separator 1011.

FIG. 17 is a cross-section along the line B-B in FIG. 13. In this figure, the extended portions RS1 of the sealing members RS are in close contact with each other, in order to form the coolant channel 1025 meandering between the cooling plane of the cathode side separator 1010 and the cooling plane of the anode side separator 1011. Also, the protruding members on the reaction plane of the cathode side separator 1010 and on the reaction plane of the anode side separator 1011 (the backsides of the grooves 1022 and the grooves 1030) clamp the membrane electrode assembly 1007 therebetween, and the grooves 1022 on the cooling plane of the cathode side separator 1010 and the grooves 1030 on the cooling plane of the anode side separator 1011 face each other to thereby form the coolant channel 1025.

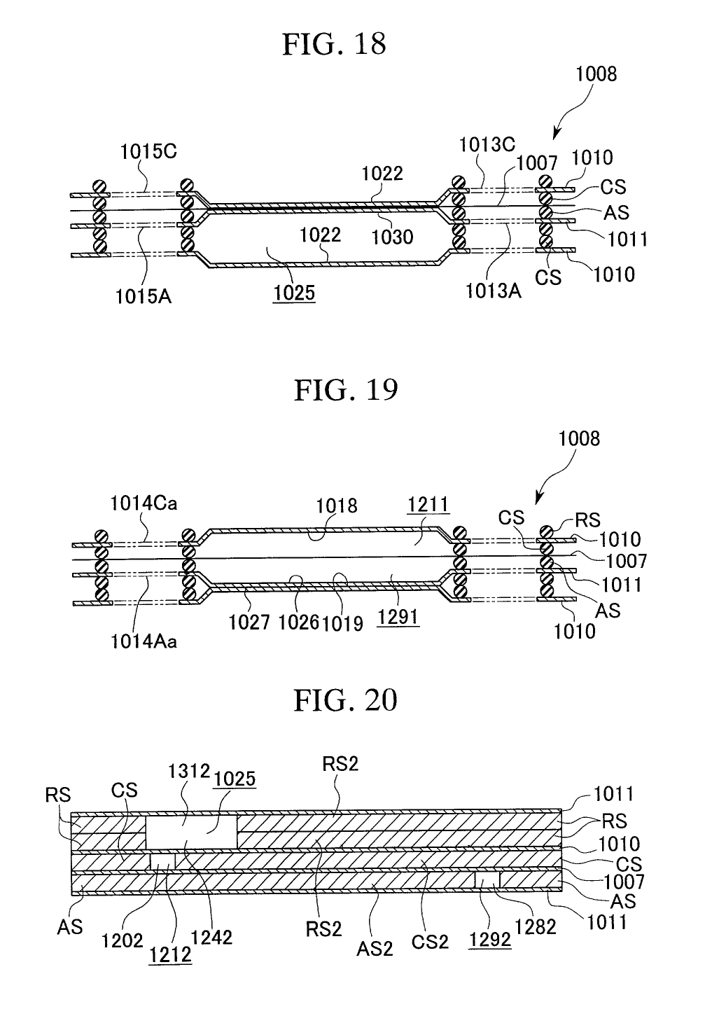

FIG. 18 is a cross-section along the line C-C in FIG. 13. This figure shows the condition where the respective protruding members on the reaction plane of the cathode side separator 1010 and on the reaction plane of the anode side separator 1011 (the backsides of the grooves 1022 and the grooves 1030) clamp the membrane electrode assembly 1007 therebetween, and the condition where the grooves 1022 on the cooling plane of the cathode side separator 1010 and the grooves 1030 on the cooling plane of the anode side separator 1011 face each other to thereby form the coolant channel 1025.

Furthermore, FIG. 19 is a cross-section along the line D-D in FIG. 13. This figure shows the condition where the grooves 1018 on the gas channel surface of the cathode side separator 1010 and the grooves 1026 on the gas channel surface of the anode side separator 1011 form the reactant gas channels 1211 and 1291 between the membrane electrode assembly 1007 and those separators, respectively, and the condition where the protruding members 1019 on the cooling plane of the cathode side separator 1010 and the protruding members 1027 on the cooling plane of the anode side separator 1011 are located closely to partition the coolant channel. FIG. 20 is a cross-section along the line E-E in FIG. 13, showing the condition where each sealing member AS, CS, RS is located closely to each other, including the respective extended portions AS2, CS2 and RS2.

In the above described embodiment, when the oxidant gas is supplied to the fuel cell 8, this oxidant gas is supplied, as shown in FIG. 12, from the inlet side communicating holes 1012Ca and 1012Cb for the oxidant gas in the cathode side separator 1010 to the gas channel surface of the cathode side separator 1010. Then, the oxidant gas flows into the U-shaped reactant gas channel 1211 having the extended portion CS1 as the boundary portion and the connecting path 1201 as the turning portion, and the U-shaped reactant gas channel 1212 having the extended portion CS2 as the boundary portion and the connecting path 1202 as the turning portion, and the reacted gas is exhausted from the outlet side communicating hole 1013C for the oxidant gas.

On the other hand, in a similar manner, when the fuel gas is supplied to the fuel cell, this fuel gas is supplied, as shown in FIG. 14, from the inlet side communicating holes 1014Aa and 1014Ab for the fuel gas in the anode side separator 1011 to the reaction plane of the anode side separator 1011. Then, the fuel gas flows into the U-shaped reactant gas channel 1291 having the extended portion AS1 as the boundary portion and the connecting path 1281 as the turning portion, and the U-shaped reactant gas channel 1292 having the extended portion AS2 as the boundary portion and the connecting path 1282 as the turning portion, and the reacted gas is exhausted from the outlet side communicating hole 1015A for the fuel gas.

As a result, by the supplied fuel gas and oxidant gas, electric energy is generated between the cathode side separator 1010 and the anode side separator 1011 via the solid polymer electrolyte membrane, to thereby generate power.

Furthermore, when the coolant is supplied to the fuel cell, this coolant is supplied, as shown in FIG. 13 and FIG. 15, from the inlet side communicating hole 1017 for the coolant in the cathode side separator 1010 and the anode side separator 1011 to the cooling plane of each separator 1010, 1011. Then, the coolant flows into the meandering coolant channel 1025 having the extended portions RS2 and RS1 as the boundary portion and the connecting paths 1242 and 1312 and the connecting paths 1241 and 1311 as the turning portion, and is exhausted from the outlet side communicating hole 1016 for the coolant. As a result, the fuel cell can be cooled.

According to the embodiment, the first routes 1211B and 1212B of the gas channels 1211 and 1212 of the cathode side separator 1010 merge. The second returning routes 1291B and 1292B of the gas channels 1291 and 1292 of the anode side separator 1011 merge. In the second returning routes 1291B and 1292B flowing together, the speed of the gas is increased, and as a result, the water condensed in the gas channels can be effectively discharged. Thus, the gas channel surfaces of the separators 1010 and 1011 can be prevented from being blocked by the condensed water, thereby provide the uniform reaction.

Moreover, in this embodiment, in both the cathode side separator 1010 and the anode side separator 1011, the number of grooves 1018 and 1026 (five grooves) reaching from the connecting paths 1201 and 1202 and the connecting paths 1281 and 1282 to the outlet side communicating hole 1013C and the outlet side communicating hole 1015A is fewer than the total number of the grooves 1018 and 1026 (4+4=8 grooves) reaching from the inlet side communicating holes 1012Ca and 1012Cb and the inlet side communicating holes 1014Aa and 1014Ab to the connecting paths 1201 and 1202 and the connecting paths 1282 and 1282. Hence, the speed of each reactant gas can be increased, thereby enabling effective exhaust of the generated water. In order to increase the speed of the reactant gas, it is necessary to decrease the number of grooves on the outlet side, taking into consideration the portion decreased by using the reactant gas for the reaction.

The separators 1010 and 1011 have pairs of the gas channels 1211 and 1212, and 1291 and 1292. Therefore, when the load is low, one of pairs of the gas channels may be used. Since, depending on the load, two pairs of gas channels, or a pair of gas channels may be used, so that apparent current density can be adjusted to increase the system efficiency. When the load is low, a pair of gas channels is used, more reaction gas than necessary does not have to flow in order to discharge the produced water. Hence, the utilization rate of the reaction gas is increased, and the system efficiency is also increased.

The gas channel inlet AIN and the outlet AOUT of the anode side separator 1011 are provided in one of the edges (for example, the left side edge of FIG. 14), and the gas channel inlet CIN and outlet COUT are provided in the other edge (for example, the left side edge of FIG. 12). Hence, water accumulated in the turning portions 1281 and 1282 of the cathode side separator 1010 passes through the solid polymer electrolyte membrane and back diffuses and moves to the gas channel inlet AIN of the anode side separator 1011. As a result, the fuel gas is sufficiently humidified to thereby accelerate the reaction. Therefore, the humidification device can be made smaller as the gas is sufficiently humidified, and related equipment for discharging water can be simplified as the water to be discharged is decreased.

Further, the returning routes 1291B and 1292B of the anode side separator 1011, which flow together, correspond to the returning routes 1211B and 1212B, which flow together and contain much water. Hence, the returning routes 1291B and 1292B, which do not contain much water, can be humidified by back-diffusion.

In the above embodiment, since the inlet side communicating holes 1012Ca and 1012Cb and the inlet side communicating holes 1014Ca and 1014Cb are set towards the outside of each separator 1010, 1011, the efficiency of thermal radiation is high and the temperature easily drops, compared to a case where these are set inside. Hence, there is merit in that even if a specified amount of water is not supplied, it is easy to maintain the relative humidity to a specified value.

The communicating paths 1201 and 1202 of the cathode side separator 1010, and the communicating paths 1281 and 1282 of the anode side separator 1011 act as the buffers for collecting the reaction gas the first routes 1211A and 1212A, and for collecting the reaction gas from the first routes 1291A and 1292A. The gas channel inlet CIN and the gas channel outlet COUT of the cathode side separator 1010 act as a part of the buffer for the inlet side communicating holes 1012Ca and 1012Cb for the oxidant gas. The gas channel inlet AIN and the gas channel outlet AOUT of the anode side separator 1011 act as a part of the buffer of the inlet side communicating holes 1014Aa and 1014b for the fuel gas.

Even if the condensed water blocks a part of the grooves 1018 and 1026, the buffer introduces the reaction gas into the grooves which are not blocked. In this case, the effective reaction area is not significantly reduced as compared with the device which has continuous gas channels without any communicating path 1201, 1202, 1281, or 1282. In a similar manner, the effective reaction area is not significantly reduced as compared with the device which has continuous gas channels 1018 and 1026 connected to the inlet side communicating holes 1012Ca and 1014Aa or the outlet side communicating hole 1013C and 1015A.

A third embodiment of the invention will now be described with reference to FIG. 21 to FIG. 23.

While the second embodiment is an internal manifold type, the third embodiment is external manifold type.

FIG. 21 shows a gas channel surface of a cathode side separator (gas channel plate) 1060. The cathode side separator is made of metal thin plate by press forming, and has a plurality of grooves (channel) 1061 extending linearly in the lateral direction in units of several grooves (four, five and four from the top).

On the cathode side separator 1060, a sealing members TS are provided at the upper, lower, and right side edges, with the exception of the left side. Extended portions TS1 and TS2 of the two sealing member TS extends from the left side edge of the cathode side separator 1060, and reaches just in front of the right side edge, without a seam, in a position dividing each unit of the groove 61. Connecting paths 1651 and 1652 are formed between the right end portions of the extended portions TS1 and TS2 and the sealing member TS. A connecting path 1682 is also formed between the left end portion of the extended portion TS2 and the sealing member TS. The communicating paths 1651 and 1652 act as a part of the buffer for collecting the gas upstream. The end of the groove 1061 in the inlet side communicating hole 1066Ca is a gas channel inlet CIN, the end of the groove 1061 in the side of the outlet side communicating hole 1067C is a gas channel outlet COUT. The gas channel inlet CIN and the gas channel outlet COUT act as a part of the buffer.

Three manifold members 1062 for the oxidant gas with a channel shape shown in FIG. 22 are attached to the left side edge of the cathode side separator 1060. Three manifold members 1062 with the similar structure are attached to the opposite right side edge. A manifold member 1063 for the coolant is attached to each of the upper side edge and the lower side edge of the cathode side separator 1060. Sealing members 1064 are provided at the contact portions of the manifold members 1062 and 1063.

The upper and lower manifold members 1062 at the upper and lower left side edges provide inlet side manifold 1066Ca and 1066Cb for the oxidant gas. The center manifold member 1062 provides an outlet side manifold 1067C for the oxidant gas. The upper and lower manifold members 1062 at the upper and lower right side edges provide inlet side manifold 1066Ca and 1066Cb for the oxidant gas. The center manifold member 1062 provides an outlet side manifold 1069C for the fuel gas. The manifold member 1063 at the lower side edge provides an inlet side manifold 1071 for the coolant, and the manifold member 1063 at the upper edge provides an outlet side manifold 1070 for the coolant.

As a result, on the gas channel surface of the cathode side separator 60, there are formed a U-shaped gas (oxidant gas) channel 1661 with the extended portion TS1 being the boundary portion, and the connecting path 1651 being the turning portion, and a U-shaped reactant gas channel 1652 with the extended portion TS2 being the boundary portion, and the connecting path 1662 being the turning portion.

That is, the U-shaped gas channel 1661 comprises a first route 1651A from the gas channel inlet CIN in the side of the inlet side communicating hole 1066Ca to the communicating path 1651 as the turning portion, and a second returning route 1661B from the communicating path 1651 to the gas channel outlet COUT in the side of the outlet side communicating hole 1067C. The U-shaped gas channel 1662 comprises a first route 1662A from the gas channel inlet CIN in the side of the inlet side communicating hole 1066Cb to the communicating path 1652 as the turning portion, and a second returning route 1662B from the communicating path 1252 to the gas channel outlet COUT in the side of the outlet side communicating hole 1067C.

A pair of gas channels 1661 and 1662 are provided on the gas channel surface of the cathode side separator 1060. The returning route 1661B and 1662B of the gas channels 1661 and 1662 merge.

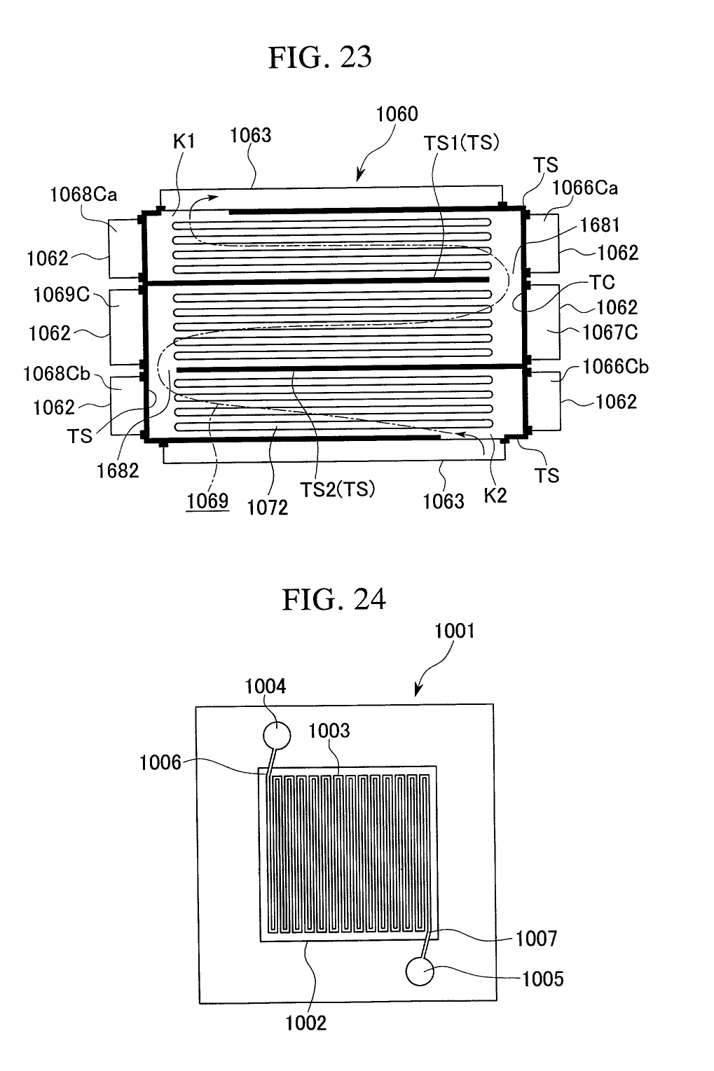

FIG. 23 shows the cooling plane on the backside of the cathode side separator 1060 in FIG. 17. On this plane, protruding members 1072 are formed at the backside positions of the above described grooves 1061. On this cooling plane, the sealing members TS are provided, with the exception of the left side of the upper side edge and the right side of the lower side edge being notches K1 and K2, respectively. An extended portion TS1 of the sealing member TS extends from a slightly upper side of the central portion on the left side edge of the cathode side separator 1060 up to just before the right side edge without a seam, in a position dividing each unit of the protruding members 1072. On the other hand, an extended portion TS2 of the sealing member TS extends from a slightly lower side of the central portion on the right side edge of the cathode side separator 60 up to just before the left side edge without a seam, in a position dividing each unit of the protruding members 1072.

A connecting path 1681 is formed between the right end portion of the extended portion TS1 and the sealing member TS. A connecting path 1682 is also formed between the left end portion of the extended portion TS2 and the sealing member TS.

Then, as described above, three manifold members 1062 in a channel form as shown in FIG. 22 are attached for the oxidant gas, at the left side edge, in a position corresponding to each extended portion TS1. Also at the right side edge on the opposite side, three manifold members 1062 having a similar construction are attached for the fuel gas. A manifold member 1063 is attached for the coolant, one each at the upper side edge and the lower side edge of the cathode side separator 1060.

In this manner, a meandering coolant (ethylene glycol) channel 1069 is formed on the cooling plane of the cathode side separator 1060, with the extended portions TS2 and TS1 being the boundary portion, and the connecting paths 1682 and 1681 being the turning portion.

The description has been made herein only for the cathode side separator 1060, but it is also applicable to the anode side separator.

Accordingly, also in this third embodiment, the same effects as in the second embodiment can be obtained by the external manifold type.

According to the embodiment, the returning routes 1661B and 1662B of the gas channels 1661 and 1662 of the cathode side separator 1010 merge, and the returning routes of the anode side separator also merge. The speed of the gas flow in the joining routes is increased, and as a result, the water condensed in the gas channels can be effectively discharged. Thus, the uniform reaction can be achieved.

Since, depending on the load, two pairs of gas channels, or a pair of gas channels may be used, so that apparent current density can be adjusted to increase the system efficiency. When the load is low, a pair of gas channels is used, more reaction gas than necessary does not have to flow in order to discharge the produced water. Hence, the utilization rate of the reaction gas is increased, and the system efficiency is also increased.

The turning point of the oxidant gas flowing on the gas channel surface of the cathode side separator 1060 corresponds to the inlet side of the fuel gas flowing on the gas channel surface of the anode side separator. Therefore, the humidification device can be made smaller as the gas is sufficiently humidified, and related equipment for discharging water can be simplified as the water to be discharged is decreased.

Because the communicating paths 1651 and 1652 act as the buffer, even if the condensed water blocks a part of the grooves, the communicating paths 1651 and 1652 introduces the reaction gas into the grooves which are not blocked. In this case, the effective reaction area is not significantly reduced.

The present invention is not limited to the above described embodiments, and for example, the present invention is applicable to a molten carbon type fuel cell other than the solid polymer type fuel cell.

While the metal separators manufactured by press-forming is described, the present invention is applicable to a separator made of molded carbon material, and to a separator with grooves formed by cutting a carbon plate.

Further, while in the embodiment the sealing member extends so as to form the gas channels, the gas channels may be formed by combining the sealing member to the ribs.

The present invention is not limited to the embodiment in which a part of the gas channel is formed by the sealing members, and is applicable to an device with gas channels manufactured by the press-forming.

This invention may be embodied in other forms or carried out in other ways without departing from the spirit thereof. The present embodiments are therefore to be considered in all respects illustrative and not limiting, the scope of the invention being indicated by the appended claims, and all modifications falling within the meaning and range of equivalency are intended to be embraced therein.

1. A fuel cell, comprising:
a membrane electrode assembly including an electrolyte membrane held between an anode electrode and a cathode electrode;
an anode side separator and a cathode side separator clamping the membrane electrode assembly;
an oxidant gas channel provided on the cathode side separator, the oxidant gas channel starting from an oxidant gas channel inlet and reaching an oxidant gas channel outlet, the oxidant gas channel having a U-shape comprising a first route, a turning portion, and a second returning route; and
a fuel gas channel provided on the anode side separator, the fuel gas channel starting from a fuel gas channel inlet and reaching a fuel gas channel outlet, the fuel gas channel having a U-shape comprising a first route, a turning portion, and a second returning route, wherein
the oxidant gas inlet and the oxidant gas outlet are provided in one side of the cathode side separator, and the fuel gas inlet and the fuel gas outlet are provided in the other side of the anode side separator.

2. A fuel cell according to claim 1, wherein
a coolant inlet is provided at one of an upper side and lower side of the separators,
a coolant outlet is provided at the other of the upper side and lower side of the separators.

3. A fuel cell according to claim 1, wherein the separators are formed from metal thin plates.

4. A fuel cell according to claim 1, wherein the gas channels have boundary portions of the turning portions constituted by at least a part of said sealing member.

5. A fuel cell, comprising:
a membrane electrode assembly including an electrolyte membrane held between an anode electrode and a cathode electrode;
a pair of separator clamping the membrane electrode assembly; and
a plurality of gas channels provided on a gas channel surface of the separator, the gas channel surface facing the anode or cathode electrode, the gas channels starting from a gas channel inlet and reaching a gas channel outlet, wherein
the gas channels partially merge.

6. A fuel cell according to claim 5, wherein
each of the gas channels has a U-shape comprising a first route, a turning portion, and a second returning route, and
the second returning routes of the gas channels merge.

7. A fuel cell according to claim 5, wherein
the gas channel inlet and the gas channel outlet of the separator close to the anode electrode are provided in one side, and
the gas channel inlet and the gas channel outlet of the separator close to the cathode electrode are provided in the other side.

8. A fuel cell according to claim 6, wherein the turning portion acts as a buffer.

9. A fuel cell according to claim 5, wherein each gas channel comprises a plurality of sub-channels.

10. A fuel cell according to claim 6, wherein the cross-sectional area of the first routes is greater than the cross-sectional area of the second returning routes.

11. A fuel cell according to claim 5, wherein said pair of separators is formed from a metal thin plate.

12. A fuel cell according to claim 5, wherein said reactant gas channel has a turning portion, and a boundary portion of said turning portion is constituted by at least a part of said sealing member.

13. A fuel cell according to claim 5, wherein said gas channel has a turning portion, and a boundary portion of said turning portion is constituted by at least a part of said sealing member.

14. A gas channel plate for a fuel cell, comprising:
a plurality of gas channels provided on a gas channel surface of the separator, the gas channel surface facing the anode or cathode electrode, the gas channels starting from a gas channel inlet and reaching a gas channel outlet, wherein
the gas channels partially merge.

15. A fuel cell according to claim 14, wherein
each of the gas channels has a U-shape comprising a first route, a turning portion, and a second returning route, and
the second returning routes of the gas channels merge.

16. A fuel cell according to claim 14, wherein
the gas channel inlet and the gas channel outlet of the separator close to the anode electrode are provided in one side, and
the gas channel inlet and the gas channel outlet of the separator close to the cathode electrode are provided in the other side.

17. A fuel cell according to claim 15, wherein the turning portion acts as a buffer.

18. A fuel cell according to claim 14, wherein each gas channel comprises a plurality of sub-channels.

19. A fuel cell according to claim 15, wherein the cross-sectional area of the first routes is greater than the cross-sectional area of the second returning routes.

20. A fuel cell according to claim 14, wherein said pair of separators is formed from a metal thin plate.

21. A fuel cell according to claim 14, wherein said reactant gas channel has a turning portion, and a boundary portion of said turning portion is constituted by at least a part of said sealing member.

22. A fuel cell according to claim 14, wherein said gas channel has a turning portion, and a boundary portion of said turning portion is constituted by at least a part of said sealing member.
